(19) United States
(12) Patent Application Publication
(10) Pub. No.: US 2009/0234616 A1
(43) Pub. Date: Sep. 17, 2009

(54) Automatic Repair Planning and Part Archival System (ARPPAS)

(75) Inventor: Frederick W. Perkins, Mclean, VA (US)

Correspondence Address: MYERS BRADFORD, PLLC, 1731 WILLARD ST., STE. 502, WASHINGTON, DC, 20009, US

(73) Assignee: Syncretek LLC, Mclean, VA (US)

(21) Appl. No.: 12/035,426

(22) Filed: Feb. 21, 2008

(51) Int. Cl. G06F 15/00

(52) U.S. Cl. 702/184; 707/104.1

(57) ABSTRACT

An automated repair structural analysis processing system for aircraft composite parts is disclosed, combining a method for digitally describing damage on composite components with a system that evaluates composite aircraft repair options for a given part design, damage set, and repair history, and provides automatic calculation of the residual strength of damaged metal and composite parts. In addition, this invention provides a system that automatically informs maintenance specialists when they will not be allowed to repair a part based on an automatic structural analysis of that part, and automatically generates an assessment of conformity with engineering acceptance standards that can be used to generate a request for engineering disposition automatically sent to the appropriate engineering or executive authority.

The U.S. Government has a paid-up license in this invention and the right in limited circumstances to require the patent owner to license others on reasonable terms as provided for by the terms of contract No. N68335-06-C-0194 awarded by the Department of Defense. This invention was made with Government support under the contract. The Government has certain rights in the invention.

### FIELD OF THE INVENTION

This invention relates generally to automated analysis for repair and maintenance of composite aircraft parts.

### BACKGROUND OF THE INVENTION

The extensive use of advanced composite materials on fixed and rotary wing aircraft has dramatically affected the methods and processes used for aircraft structural repair. In contrast to historical methods that focused on metalworking processes such as welding, sheet metal forming, and rivet fasteners to restore damaged part function, modern aircraft composite part damage repair involves complex, tailored patches built up from resin-impregnated textiles and processing that require analysis and engineering support not readily available in repair facilities or which do not exist at all in deployed field locations, to reliably restore acceptable part function. The basic chemistry of modern, high strength composite materials obviates the validity of ‘rules of thumb’, or even limiting approved repair instructions to materials and processes used in the original part manufacture, as a way to determine that the repaired part will satisfactorily provide the same form, fit and function as the originally manufactured composite part. Unfortunately, as analysis and design methods have improved over the last decade, the methods used for evaluating approved repair instructions and related technology development have not been updated, leaving a technology gap that reduces the applicability of current methods for future platforms, and unnecessarily increases aircraft downtime, operational risk, and maintenance costs.

A key consideration in modern aviation repair is the intelligent processing of work flow within the repair activities detailed to each operational unit. Methods currently in use require “man-in-the-loop” decision making, and often limited to printed reference materials such as repair manuals or to limited digitized media that supplement the printed manuals. These static references are inadequate for composite aircraft part repair analysis because of repair-induced effects that cause unpredicted post repair stresses, strains, and deformations. Even though it is widely recognized that an improved process that incorporates structural evaluation of each planned composite part repair would provide substantial benefits, current analysis techniques, such as de novo finite element model preparation and analysis or manual modification of existing finite element models, take so long that they are incompatible with the timelines of the aircraft repair, and are consequently not performed. The frequent results of attempts to repair composite aircraft parts that have not been adequately analyzed are repaired parts that may not have suitable strength, and more commonly, parts that unacceptably warp or deform in unpredicted ways during repair and therefore cannot be reused. Because of the primary need to return aircraft to service quickly and the uncertainty of composite aircraft part repair success, these avoidable problems force repair facilities to stock otherwise excess inventory of expensive spare parts. Further, in repair locations with limited workspace, such as aboard an aircraft carrier or other deployed locations, and lacking access to adequate engineering support for repair evaluation, unsuccessful repairs combined with limited space to store spare parts can cause potentially avoidable, unacceptable aircraft downtime and impairment of fleet combat capabilities, especially when current repair capabilities and techniques are overwhelmed by high damage events (e.g., hailstorms and battle damage).

Therefore, aircraft manufacturers and users have recognized the need for more automated methods of analysis of aircraft parts, especially regarding damaged composite aircraft parts. U.S. published application no. 20070061109 (“Wilke”), for example, explains the need for analysis of aircraft at the site of a damaged military aircraft, where engineering personnel may not be located for on-site assessment of the aircraft. Wilke further explains that significant delays in returning damaged aircraft to service are caused by approving and communicating aircraft disposition (e.g., repair strategy, procedures, structure usage restrictions, etc.). Each discrete step of the repair process is also vulnerable to human error. Similarly, U.S. Pat. No. 6,862,539 (“Fields”) recognizes the importance of computer-aided fatigue and structural analysis of aircraft parts. In particular, Fields acknowledges the need to provide an automated tool to enable personnel without specialized training to integrate design details associated with performing diagnostic analyses of aircraft part performance during design development and qualification, but does not address repair analysis or repair planning.

Wilke and Fields provide methods for automated analysis of certain structural elements of aircraft, including composite aircraft parts that may have been damaged. Wilke discloses an automated failure diagnostic system and Fields discloses an automated structural analysis capability. However, prior to the present invention, no automated analysis tool has additionally provided a comprehensive capability enabling unskilled personnel to immediately determine the structural response, advisability of repairing the part, and adequacy of post-repair part reuse in response to such repair details as composite material selection, processing details such as cure pressure, temperature, and temperature dwell time, and fixturing to assure conformance of the repaired part with the reinstallation geometry. Indeed, Wilke assumes that the repaired parts are structurally and geometrically equivalent to newly manufactured parts, an assumption that is not supported by actual repair experience. Fields does not address part repair, and is specific for modifications to the design prior to production.

No part is the same as the original after it has been repaired. No two repairs are the same. A competent system for repair planning analysis must acknowledge both the original design, including details such as those that might have been considered by Fields and subsequently committed to production, and also provide for analysis of the unique characteristics of needed or previously completed repairs to that individual part. Any and all structural modification to an individual part that has already been manufactured differentiates that part's performance and capabilities from its original characteristics. For parts that either have been or will be repaired, information such as the specific repair geometry and location, individual and accumulated prior repair characteristics, the individual part's structural response to the details of repair material selection (which may not be the same as the original material) and repair processing details, are factors that differentiate the repaired part. Analysis is required to determine: whether a particular composite part can be safely repaired at all, what unique fixtures might be required to assure that the repaired part has the needed geometry and strength, which parts can be repaired in the field, the strength of emergency repairs, which need to be returned for depot level maintenance or even to the manufacturer for more extensive repairs, and which parts need to be procured because repair success is unlikely, as well as logistical information necessary to return the aircraft to service as rapidly as possible. Prior to the present invention, no automated tools were available to provide the needed level of detail. It was not previously possible to queue a specific aircraft for repair based on structural analysis of specific part repairs and determining their post-repair availability and suitability for the use of aircraft-level analyses, such as the automated analysis provided, for example, by Wilke or Fields. Consequently, in practice, the utility of Wilke was severely limited by its unsupportable assumptions of repaired part performance that were not matched by actual practice. The current invention does in fact provide part-specific data needed for Wilke to potentially perform a useful function.

Wilke, for example, predicts the structural suitability of flight vehicles by representing components in a complex vehicle, represented as a multiplicity of individual parts, those parts represented as each either possessing nominal strength or, if observed damage exceeds certain threshold criteria, as having no strength. In contrast with their representation in Wilke, most damaged parts will, in fact, exhibit diminished but still substantial strength. ARPPAS provides a way to calculate the diminished strength of such parts, and provides objective engineering analysis data that may be used to evaluate the serviceability of such flight vehicles with continued use of damaged parts based on analytically incorporating the diminished but still potentially significant residual strength of damaged parts in the flight vehicle representation. It also provides numerical data in standard formats, such as bdf files, MSC Patran databases, and load response numerical data, that may be automatically or manually reformatted and used as inputs to vehicle level simulations such as Wilke, to improve the fidelity of their results. This is a significant improvement over current standard practice, which requires either the judgment of repair crews without the benefit of engineering support, or such summary and coarse part strength evaluation procedures as described in Wilke, which do not analyze individual damaged part residual structural contributions to overall vehicle serviceability.

Accordingly, there is a need for an integrated automated tool to analyze damage to individual composite aircraft parts, prescribe repair materials and procedures based on that individual part's unique combination of design, damage definition, and previous repair history, and provide specific timely repair analysis data rapidly enough to enable the aircraft to be immediately queued for repair and safely returned to service as quickly as possible.

### SUMMARY OF THE INVENTION

This invention provides a fully integrated automated repair structural analysis data processing system for aircraft composite parts, designed for use by either or both experienced engineers and people with no specialized engineering training, under the remote control of engineering experts who control the data inputs and operating parameters of the system, and providing engineering analysis results in near real time to support repair planning for, and disposition of, damaged composite aircraft parts. The system disclosed herein combines a method for digitizing damage definitions on composite components and electronically storing the damage and repair definition associated with individual parts in electronic databases so that each part's damage and repair history is available electronically via database query, utilizes a GUI for inputting damage and repair parameters and outputting engineering data to the user, with an automated method that evaluates the structural consequences of composite repair material selection and processing options for a given damage set and provides structural analysis outputs such as deformation of the repaired part, strength, residual stress and strain distribution, and other structural engineering data, within a very short time (a few minutes), storing the analysis output and related files in standard electronic databases including relational database form so that it is accessible to, and may be used in combination with, other processes reliant on ready access to the archived data. Further, the electronic data storage is readily accessible via database query to reveal any individual or class of parts, number of parts in inventory, repair history of each or all, locations of repair for each or all, numbers of repairs for any or all, and similar information. The invention supports the need for individual part analysis and the need for a current comprehensive database of aircraft parts damaged, in use, and in repair for logistics and inventory planning, all supporting the maximum utilization of aircraft by automating the low level analysis processes intrinsic to aircraft part damage assessment the high performance composite aircraft part repair planning and assessment process.

### BRIEF DESCRIPTION OF THE DRAWINGS

FIG. 1 is a flowchart showing the components of an exemplary process of the claimed invention.

FIG. 2 is an engineering drawing depicted on the GUI of the present invention.

FIG. 3 is a chart illustrating the deformation contours as determined in an example of the present invention.

FIG. 4 is a chart illustrating the deformation contours as determined in an example of the present invention in which ARPPAS demonstrates an acceptable repair using alternative graphite composite material.

FIG. 5 is an additional engineering drawing depicted on the GUI of the present invention.

FIG. 6 an additional engineering drawing depicted on the GUI of the present invention showing an analysis of a repair including a prior repair.

FIG. 7 is a chart illustrating the deformation contours as determined in an example of the present invention in which ARPPAS demonstrates an unacceptable repair based on the practice of replacing damaged composite material with original materials.

FIG. 8 is a screenshot of the GUI depicting analysis results of the present invention and indicating an acceptable repair.

FIG. 9 is a screenshot of the GUI depicting an example of the present invention as shown on a GUI.

FIG. 10 is a data table showing representative data for node geometric definition as used in the present invention.

FIG. 11 is a data table showing representative data for element definition by constituent nodes as used in the present invention.

FIG. 12 is a data table showing representative data related to viewing a repair area in the GUI, as used in the present invention.

FIG. 13 is a data table showing representative data related to a list of engineering defined composite materials defined by individual textile ply characteristics and their layup angle relative to the base, as used by one embodiment of the present invention.

FIG. 14 is a table of textile ply material engineering data used in defining the composite materials according to a process of the present invention.

FIG. 15 is an exemplary table of engineering data of the type used to form the bulk data file of the present invention.

FIG. 16 is a screenshot of the GUI depicting analysis results of an example of the present invention indicating an unacceptable repair.

FIG. 17 is a screenshot of the GUI depicting analysis results of the present invention in the form of a three dimensional chart of displacement contours for an analyzed repair.

FIG. 18 is a detail of screenshot of the GUI depicting an engineering drawing of an example of the present invention.

FIG. 19 is a detail of a screenshot of the GUI depicting analysis results of the present invention in the form of a chart of the analyzed repair area.

FIG. 20 is a screenshot of the GUI depicting analysis results of the present invention and indicating an unacceptable repair.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

A method and system for computerized integrated repair analysis of composite parts is described herein, where the method comprises various steps including: identifying a composite part in need of repair; entering into a computer data describing the composite part; executing an automated computer assisted engineering analysis of the individual composite part, wherein the computer assisted engineering analysis considers a repair process; and determining projected properties of the individual composite part.

The invention is especially useful for automatic analysis of composite aircraft parts that have been damaged or are in need of repair analysis. Modern aircraft parts are frequently manufactured using composite materials, as one skilled in the art will appreciate. By “part,” this invention contemplates analyzing discrete portions of aircraft structure, which are manufactured as discrete physical objects and joined to other parts to assemble flight vehicles. An individual composite part may be, for example, a panel, a portion of a flap or entire flap, or any continuous composite part or sub-part that contains composite material as some portion of its makeup.

An important aspect of the present invention is using an automated computer assisted engineering analysis to process the part and repair data. This is accomplished by processing data describing the part into a bulk data file. A computer assisted engineering analysis is employed, such as a finite element analysis program, especially those such as NASTRAN, MSC Nastran, NE Nastran, MSC Dytran, DYNA, LS Dyna, Abaqus, Algor, IDEAS, and MSC MARC, Pro/ENGINEER Mechanica, or any similar program. Another aspect of the present invention is the ability to automatically build the bulk data file without the assistance of an engineer or other technical personnel. This is facilitated, in part, by another capability of the present invention, which is to display graphical representations of the part, optionally allowing the user to select various views of the part, including an engineering drawing. Data may be provided for the automatic analysis by one or more electronic databases, especially a relational database. According to the present invention, part-specific data may be relayed to a relational database once a repair analysis has been performed and a repair completed. This allows for establishment and maintenance of a historical database of individual part characteristics, including an incremental history of that particular part's repair instances.

The method of this invention may be implemented on a system comprising a single computer or in a distributed computing environment. The method and system are designed to provide quantitative and qualitative results to assist in the determination of whether a proposed repair would lead to suitable results for the individual part analyzed.

More specific details of this invention are described according to the figures and examples set forth in further detail below.

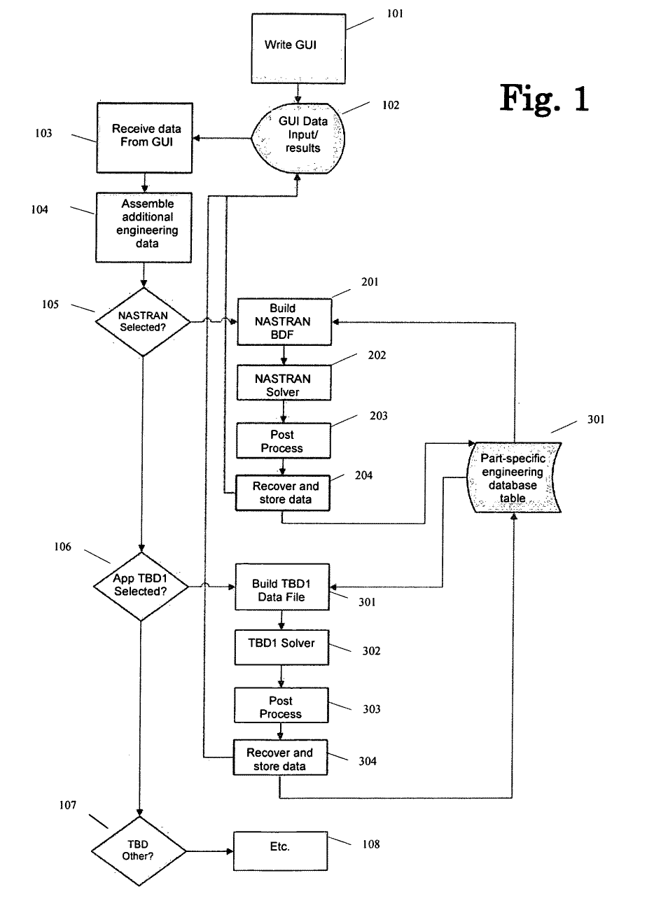

FIG. 1 illustrates an overall architecture of a system, in accordance with a non-limiting example of implementation of the present invention intended to provide an automatic repair planning and part archival system (ARPPAS).

ARPPAS relies on a structural engineering model such as a finite element model representation that is both geometrically and mathematically representative of a particular part so that particular regions of interest may be mapped from the actual part onto the structural model for analysis. ARPPAS favors engineering analysis of the discrete part over using nominal or historical data as a surrogate for analysis of the actual part's unique characteristics and history. ARPPAS goes beyond assessing vehicle-level performance by providing detailed analysis of specific parts, taking into consideration the actual properties, including repair histories, of the specific part. ARPPAS identifies parts by their individual identification marks, commonly known as the part identification number or ‘part ID’. ARPPAS is not limited to relying on predetermined assessments of part characteristics for simplified representations as lumped components, as is the case for many structural components in a typical vehicle-level analysis model such as Wilke. Instead, ARPPAS calculates the part response to repair procedures based on a point-by-point digitized structural representation of the individual part and its unique repair history. Rather than assigning a structural capability value to any part or any portion of a part, ARPPAS instead calculates structural properties based on an individual part's unique constituents such as geometry, base material composition and properties, repair location and properties for one or more prior repairs, and other structural elements that may be included in the part's analytic model.

Therefore, in an embodiment of the present invention, a part is identified that is in need of repair analysis. Any suitable diagnostic method may be employed to determine that repair is desired or required. Repair includes any post manufacture modification including absence of material when the missing material definition is used as a basis for damage assessment or residual part structural capability assessment by ARPPAS, as described below.

Once the part is identified, the part ID is determined and repair area is defined by use or processes external to ARPPAS. In an embodiment of the present invention a computer with a Graphical User Interface (GUI) provides a means for a user to input into ARPPAS such data identifying a part based on its identification number and also specifying the desired repair area.

A Graphical User Interface (GUI) includes both its visual manifestation presented to the user on a computer screen and the underlying software and supporting computer capabilities that define and enable its functions.

As depicted in the flowchart of FIG. 1, one embodiment of the present invention is executed according to the process steps set forth in the flowchart. A GUI is provided 101. The GUI can include any suitable graphics interface to display the subject data. In a preferred embodiment, the GUI additionally is capable of data input, for example a screen with a touch-pad. In a preferred embodiment, the GUI enables a user to select a specific aircraft part from a list of parts available from an electronic database using a part ID. In this embodiment of the present invention, ARPPAS sorts through all of the instances of the selected part stored in the database and displays the latest version to the user, since the latest version typically would have the most current record of accumulated repairs. There is no limit to the types of parts, nor number of individual part ID's related to any part type, nor to the number of repair instances for any particular part ID that might be included in the database. It may be appreciated that any prior repair state earlier than the latest stored version, might alternatively be selected for analysis in ARPPAS.

After the particular part representation is selected by user selection of the part ID in the GUI, additional data regarding the part may be entered and displayed 102. In a preferred embodiment of the invention, the user next selects the view of the selected part that shows either the affected area or any area desired to be analyzed for repair. The data are processed and displayed on the GUI. For example, the user may desire to select a specific portion of a wing part, such as a section of the leading edge. Upon user selection, ARPPAS posts an engineering drawing of the selected part view, optionally including a graphical representation that includes all of the previous repairs on the part view and repair definitions that had been automatically recorded in the electronic database for that part during prior analysis of the part. It may be appreciated that posting the latest graphic is not intrinsic to ARPPAS operation, but is a convenience for the user in a preferred embodiment of the invention. It may also be appreciated that all portions of the part and all repairs to all portions of the part may be represented in the database representation of that part, but there may only be a minority of, or even none of the previous repairs displayed in the particular part view selected by the user.

The newly defined current repair geometry is entered into a computer, 103. ARPPAS digitizes the repair geometry along with additional engineering data, and converts it into machine readable electronic data 103, 104.

The newly defined repair geometry is visually displayed on the engineering drawing posted on the GUI, providing visual feedback for the user.

The next step, labeled in FIG. 1 as “Assemble Additional Engineering Data,” 104, is described in further detail as follows. The machine transforms the repair area definition coordinates provided by the user into the reference frame of the digitized part structural model coordinate system. Reference structural data are recalled from an electronic database (for example in a relational database table or in a spreadsheet format). That database uniquely associates geometric nodes with particular aspects of the part's geometry. This process is used for all such engineering analyses, and consequently, it supports multiple solvers and applications. The nodes are sorted to determine which are included within the defined repair area. A list of the included nodes is then used to sort for the discrete elements, such as individual finite elements, delimited by those nodes. Defining discrete structural elements in terms of geometric nodes delimiting those structural elements is a widely accepted practice, and is generally applicable to all computer assisted engineering structural analysis applications, so it does not imply use of any particular product. The identification numbers of the structural elements that are included within the repair area are then reported back to the main program.

The program employs at least one computer-aided engineering analysis subroutine specified by user solver selection in the GUI. Suitable programs for executing the engineering analysis include, for example, finite element analysis programs. Specific examples of suitable programs for executing the engineering analysis include NASTRAN, MSC Nastran, NE Nastran, NX Nastran, MSC Dytran, DYNA, LS Dyna, Abaqus, Algor, IDEAS, Pro/ENGINEER Mechanica, and MSC MARC. One of skill in the art will appreciate that new programs that provide similar functionality and might be incorporated into the ARPPAS environment are frequently developed and the present invention is not limited to use of any specific program. Once a specific solver and associated subroutine is selected, the analysis process information and engineering reference data are recorded as a new record unique for that part ID and repair instance in the master Repair Record database table. Once recorded for safekeeping in the distributed computing environment, preferably on a server dedicated to that function, all necessary engineering information for the analysis is passed to the designated subroutine, including selected elements, material specification for those elements, thermal characteristics and properties of the material selected for the repair, etc.

Once the bdf has been built, 201, it is submitted to the solver for analysis, 202. The bdf is built to conform to the requirements of the selected CAE program. Following analysis, the data is postprocessed to retrieve needed engineering data, 203.

A visually distinct construct, such as a red color, can be used to distinguish a new repair definition from prior repair definitions. In a preferred embodiment, the program stores the data related to the new repair in a database record unique to that part and the current repair instance, incorporating the newly defined repair material characteristics and its geometry into an updated digital representation of the part including its current repair state, along with the remaining native material and prior repairs. Thus, in this preferred embodiment, the newly defined repair characteristics supersede the characteristics of the native material and any previous repairs in its application area. ARPPAS then automatically queries the database again to assemble additional data needed for the analysis, such as the material properties of the portion of the part where the newly defined repair is located, its glass transition temperature (note that ‘glass transition temperature’ refers to the chemical and physical characteristics of the cured composite material, not the composition of the constituent textiles in the composite material such as fiberglass or graphite), the same information for all prior repairs, the details of the textile plies and their relative orientation in the composite material for the newly defined repair and for prior repairs, the material properties of the rest of the part, additional applied loads (such as force, temperature, overpressure, or vibration loads at certain locations on, large portions of, or over the entire extent of the part) and boundary conditions and constraints (such as displacement at one or more points on the part). ARPPAS automatically assembles all of the data needed to execute an automated engineering analysis of the part including its geometry, material information, loads, and thermal information into a machine readable data file, for example, a bulk data file used in finite element analysis.

ARPPAS stores the machine readable data file and, after storing the data, processes the data in the file (for example, using MSC NASTRAN) to produce an analysis output data file (for example, an xdb file) 105.

ARPPAS also provides the user with the option of using alternative solutions. If the user had instead selected an alternative solver via data entry in, for example the GUI at 101, ARPPAS logic would instead execute an alternative but functionally equivalent logical path, shown in the first instance at 106 as TBD1 (for example, an alternative formulation of a NASTRAN-based analysis that included a different set of loads) or in a second instance at 107 and 108 as TBD2, such as use of an alternative solver such as MSC Dytran that includes a formulation that would analyze the effects of an in-flight collision with a bird on the part. Each of these different formulations would provide different types of analysis and potentially distinct sets of output data, with steps 301, 302, 303 and 304 being analogous to steps 201-204 as depicted in FIG. 1. The user interaction would remain the same, since the same data is required of the user. All processes needed to support the one or more alternative solvers are internal to ARPPAS. ARPPAS can support a multiplicity of such analyses by encapsulating the unique requirements of each analysis type's data file formats and parameters in a discrete subroutine such as TBD1 or TBD2 dedicated to that purpose.

In a preferred embodiment, ARPPAS verifies that all required user inputs have been specified and then presents the user with several options related to program execution, for example, executing the analysis, updating the geometry without executing the analysis, or aborting the analysis. If the user elects to execute the process, analysis proceeds by constructing a bulk data file for processing, for example by NASTRAN, 201.

A subroutine generates a bdf (bulk data file) by polling relational databases for needed geometry and defining properties based on the user inputs and previous repair definitions recalled from the electronic database, 201. Note that the bulk data file may be built fresh each time based on the new user inputs and reference information. This may be important to assure that the part definition data remains fresh throughout the part lifetime. The bdf is stored for each repair instance, providing an engineering audit trail if one should ever be desired, 301. Once the bdf has been built it is submitted to the solver for analysis.

In this preferred embodiment, a NASTRAN solver processes the bulk data file, 202 and undergoes one or more post-processing algorithms, 203, before the analysis output results are stored, 204.

Following analysis, the data is post-processed 203 to retrieve needed engineering data. ARPPAS automatically executes another data processing program (such as MSC Patran), 106 to extract the geometry, displacements, stresses, strains, and other engineering data related to the repair configuration from the analysis output file.

The data extracted may include, for example, the maximum displacement of the part due to the repair-induced and other applied loads, the maximum shear stress, the maximum shear strain, the maximum principal strain, maximum principal shear, etc, and graphical displays of these data.

In a preferred embodiment, ARPPAS queries the database for approved values of allowable parameters for a variety of engineering data, such as stress, strain, displacement, etc, and compares the calculated data with the allowed parameters. It may be appreciated that a wide range of engineering data are available from automated structural analysis programs such as finite element programs, and that various of these engineering analysis results may be compared with standards and used as acceptance criteria for the repaired part.

An additional process, 107, may take data from the results of the analysis and represent the data graphically on the GUI, for example, by charting false-color plots of strain and stress across the repaired part.

If the calculated engineering analysis output data do not conform to the approved limits for those parameters, then the existence of a nonconformance may be visually displayed in the GUI by use of characteristic colors and symbols, such as red highlights and a red STOP sign similar in proportions and color to a traffic sign. If, on the other hand, all engineering analysis output data conform to the acceptance standards, then a symbolic green GO sign is displayed in the GUI. These summary data are also recorded in the database for this repair.

The repair record analysis summary and locations of result files are recorded in, for example, an ANSI-standard SQL relational database table, where they serve as an incremental and comprehensive reference for subsequent calculations and a source for other potential users of the data including program managers and analysts seeking details on part repair requirements, frequency, location, and other relevant data. The repair details related to the part geometry are captured in indexed database tables easily cross-referenced to the repair data summary. All of the engineering data, results, and graphics related to any and every analysis event are stored in a discrete folder indexed to the repair summary database entry for that repair instance. Each repair record also references the previous repair instance for that individual part, so that a complete trail back to the virgin part is easily established, including all analyses and information input and generated throughout the part's entire service history.

An important aspect of the present invention is the interaction with one or more electronic databases. In a preferred embodiment, data is stored in SQL (Standard Query Language) databases. SQL queries and posts may be accomplished using ANSI standard SQL statements, for example, those implemented in Matlab.

The present invention contemplates use of at least two separate databases, though either more or fewer databases might be used and provide acceptable functionality. One holds archival data that does not change between repair instances. This database includes the following examples of tables for:
Node geometric definition for each part type and view of that part, assuring that registration of the user repair geometry onto the elements will not overlap onto other portions of the part;
Element definition by constituent nodes for each part type and view of that part;
Data related to each view, such as the name of the view, the geometric limits for the repair area in the drawing graphic, the scale between the drawing view shown in the GUI and the actual geometry;
A list of all nodes and their geometric definition for each part type; and
A list of all elements and their nodal definition for each part type.
   A second database is dedicated to the incremental records queried and generated by the repair process and includes those tables that are updated with information for individual parts and repair instances. This database includes:
A master repair record holding part ID's for each part eligible for repair analysis, indices, graphic ID's, location and size of each repair, paths to data locations, paths to previous records, etc;
An element record for each part and view of that part that includes the element ID for each eligible solver, the element nodal definition, a record of the current repair zone corresponding to its continued use of virgin material or the alternative material used to repair that particular structural element (this architecture provides robustness and versatility to accommodate multiple solvers and an arbitrarily large numbers of repairs off of a common database);
A list of engineering defined composite materials (preferably up to 15 layers) defined by individual textile ply characteristics and their layup angle relative to the base (combined with the user-defined base angle, this defines the composite material used in the analysis based on the underlying textile ply data); and
A list of textile ply material engineering data used in defining the composite materials.
   This formulation supports anisotropic (commonly orthotropic) composite materials as well as symmetric composite materials. This provides complete generality in the part and repair definition including the typically isotropic metal components of the part, the potentially isotropic composition of certain composite materials, and the potentially anisotropic (typically orthotropic) material properties of other composite materials and the associated automated engineering analysis.

The results, in a preferred embodiment of the invention, are shown in a GUI side by side with an engineering drawing, so the user can immediately identify areas of concern and locate such areas on the actual part. The results may clearly show important text and graphical information such as the title identifying the maximum shear strain, the corresponding false color map showing the strain contours, and the color coded scale with numerical stress values corresponding to the colors. It may be appreciated that a full range of additional data may also be extracted from the analysis, including strain, stress, and deformation at any point, natural frequencies, strength margins, buckling loads and margins, etc., and that the results of those analyses are dependent on the particular part design, its original composition, and its repair history, not on nominal data for a newly manufactured part, nor on the assumption that the repaired part will have the same strength, performance, geometry, and structural characteristics as a newly manufactured part even if repaired per instructions.

Also in a preferred embodiment, a specialized database preferentially formatted for the CAE product used for a particular repair and configuration is stored in an electronic archive along with the bulk data file and the output results. This feature allows audits and additional detailed analysis by experienced engineers, if required, to proceed very rapidly and accurately, starting with the exact same data used for the automatic analysis, outside of the ARPPAS environment. For example, the computer program analysis product MSC Nastran is used in a preferred embodiment. Nastran operates on the bulk data file to produce an xdb file that contains the analysis output data. The post processor MSC Patran operates on the xdb file to produce the output graphics and additional output numeric data. While operating on the xdb file, Patran also produces a Patran-specific database that includes the geometry, material characteristics, and Patran-specific data. This Patran database is stored and may be used for additional analysis should that be required by an expert analyst or manager by invoking Patran alone without using ARPPAS. (Note that the Patran database is not necessarily involved in the ARPPAS analysis, but rather may be one of the outputs.) For example, an additional aspect of the output results may be desired that is not included in the automated ARPPAS results and that preferentially requires use by an experienced engineer of an application such as Patran to perform additional analysis. One such additional aspect, showing the maximum strain distribution from below the panel (recall that the previous results automatically produced by ARPPAS were a top view) is generated using the ARPPAS-generated Patran database. The additional aspect shows, for example, the propagation of the repair-induced shear strain into the reinforcing webs that were not altered during the part repair. An expert user using Nastran, Patran, and the Patran database, with full confidence that the data matches the as-repaired part and previous analyses, might also now perform other additional analyses, such as eigenvalue analysis or thermal analysis, using the same Patran database. As one of ordinary skill in the art would expect, other CAE programs will have similar results and outputs.

The following examples explain the invention in further detail. As one skilled in the art will appreciate, the examples illustrate embodiments of the present invention and in no way limit the scope of the claimed invention.

### Example 1

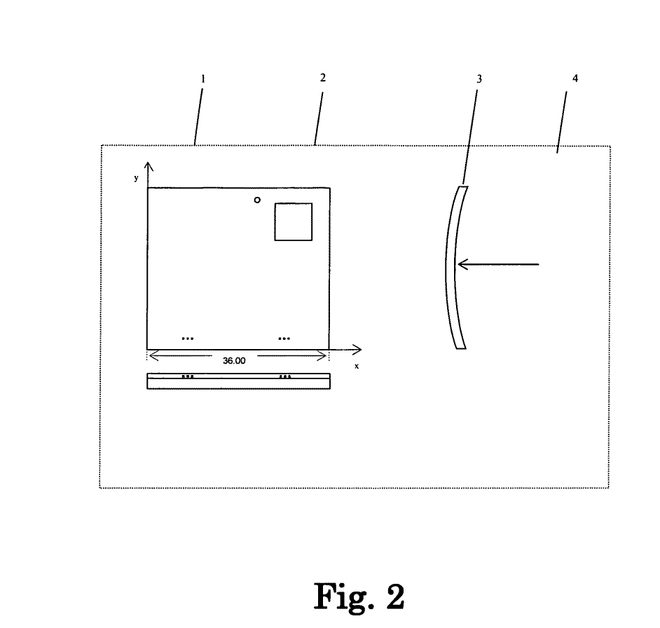

Example 1 demonstrates how ARPPAS operates to achieve an accurate repair analysis. Consider the case, depicted in FIG. 2, of a representative aircraft part similar to a fuselage access door 1 having a reinforced composite panel having square dimensions of 36 in. per side with a needed repair 2 centered at (27,27) with repair length and width both equal to 9 inches, and a curvature 3 as shown in FIG. 2.

The original panel surface is specified as a glass composite material, for example five layers of Cytec CE 9000/7781 prepreg fiberglass. Current maintenance practice is to replace the damaged material with the same glass composite material, processing it the same as the original material. For example, five patches of new Cytec CE 9000/7781 prepreg fiberglass, each with the correct size to cover the 9 inch by 9 inch repair area 2 (with appropriate detailing, such as tapered contours to assure a bond at the perimeter) would be cut and laid into the panel cutout area. A base and cover, such as metal plates with the intended final surface curvature, would be applied to both sides of the patch. The temperature of the patch would then be raised by the application of external heat to cure the prepreg materials while pressure applied to both top and bottom cover would squeeze excess air out of the patch material and assure conformance of the repair with the covers, for a period of time of the order of an hour. (The actual cure period can change depending on several factors, and for this hypothetical example, it is only representative.) The temperature is then allowed to cool and the covers are removed. The shape of the composite patch becomes fixed when the temperature drops below the glass transition temperature, which for this material is about 350 degrees F. As the temperature falls below that temperature, the patch shrinks. The amount of shrinkage is determined by the cured composite material's coefficient of thermal expansion and the difference between the glass transition temperature and the ambient temperature of the part. This shrinkage causes the entire part to contract in the direction of the repair, leading to undesirable displacement and residual stresses and strains. ARPPAS predicts these effects very quickly during the repair planning process, before the actual repair is begun.

However, as shown in this example, because ARPPAS offers the repair planner alternative selection of a preferred repair material, such as a much stiffer graphite composite material, and a means to compare the results of the alternative material on the repair figures of merit, the repair planner has the heretofore unavailable means to perform analysis-based repair planning quickly and accurately, and base the repair plan on the comparative benefits of alternative repair strategies.

After identifying this particular part and its need for repair and defining the repair area, analysis by ARPPAS is conducted as follows:

Step 1: The individual part ID is selected from the list of part ID's available from the electronic database.

Step 2: The user selects the view of the selected part that shows the affected area.

Step 3: The view showing the repair area is selected by the user. Upon user selection, ARPPAS posts an engineering drawing of the selected view 4.

Step 4: The repair geometry is entered into a computer and converted into machine readable electronic data.

Step 5: The repair geometry is visually displayed on the engineering drawing posted on the GUI, providing visual feedback for the user.

Step 6: ARPPAS queries an electronic database for the composite materials approved for repair of this part, for example 5 ply Cytec CE 9000/7781, the original material for the virgin part.

Step 7: The approved composite material options are loaded into the GUI. Once the approved options are loaded into the GUI, the popup window with the approved available material options turns a characteristic color (for example yellow) alerting the user to the requirement for their selection. The user then selects exactly one of the options from a popup window. (Note that here and in all other instances, the GUI is only a convenient means to enter the needed data. Other formats, such as data or text files, or manual data entry would also support ARPPAS operation. User of a GUI is not intrinsic to ARPPAS function.) Using the current standard repair practice, the user selects the original composite material, 5 ply Cytec CE 9000/7781.

Step 8: ARPPAS then queries the database again to see if any additional information is required from the user to fully define the material use. For example, if the material has a preferred angular orientation, then ARPPAS will reconfigure the GUI to provide a means for the user to enter the needed data, again changing color to alert the user to the need for additional data entry. The user then enters the data as required.

Step 9: ARPPAS then checks to verify that all required user inputs have been provided.

Step 10: Once all user inputs are complete, ARPPAS offers the user several options related to program execution from which the user must select one, for example, either execute the analysis, update the geometry without executing the analysis, abort the analysis, exit the program, etc.

Step 11: If the user elects to execute the analysis, the program stores the data related to the new repair in a database. ARPPAS then automatically queries the database again to automatically assemble additional data needed for the analysis, such as the composite material properties of the balance of the part, its glass transition temperature (note that glass transition temperature refers to the chemical and physical characteristics of the cured composite material, not the composition of the constituent textile fibers in the composite material such as fiberglass or graphite), the details of the textile plies and their relative orientation in the composite material, the material and geometric properties of the rest of the part, additional applied loads (such as overpressure or vibration loads at certain locations on the part) and boundary conditions and constraints (such as displacement at one or more points on the part). ARPPAS then automatically assembles all of the geometry, material information, loads, and thermal information into a machine readable file (for example, a bulk data file used in finite element analysis). ARPPAS then stores the machine readable data file and processes the data in the file (for example, using MSC Nastran) to produce an analysis output data file (for example, an xdb file). ARPPAS then automatically executes another data processing program (such as MSC Patran) to extract the geometry, displacements, stresses, strains, and other engineering data related to the repair configuration from the analysis output file. The data extracted include, for example, the maximum displacement of the part due to the repair-induced and other applied loads, the maximum shear stress, the maximum shear strain, the maximum principal strain, maximum principal stress, etc, and graphical displays of these data.

Step 12: ARPPAS then again queries the database for approved values of allowable parameters for a variety of engineering structural analysis output data, such as stress, strain, displacement, etc, and compares the calculated output data with the allowed parameter value data.

Step 13: If the calculated data do not conform to the approved limits for those parameters, then the existence of one or more nonconformances is visually displayed in the GUI by use of characteristic colors and symbols, such as red highlights and a red STOP sign similar in proportions and color to a traffic sign. If, on the other hand, all output data conform to acceptable standards, then a symbolic green GO sign is displayed in the GUI. These data are also recorded in the database record for this individual part and repair instance.

Step 14: ARPPAS automatically loads the user-selectable graphical plots of engineering output data into the GUI for display to the users. Thus the user enjoys not only unambiguous indications of compliance or non-compliance with the engineering standards for the planned repair, but also may examine the details of the results in a convenient graphical format.

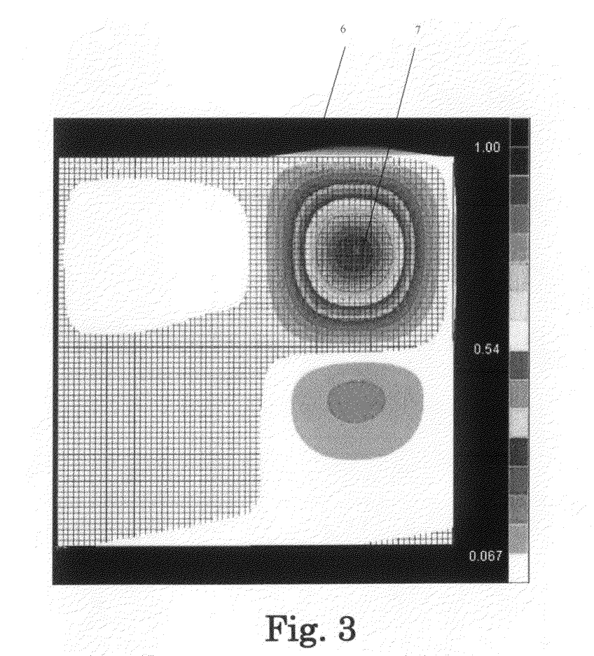

The results of ARPPAS, depicted as a chart of deformation contours 6 in FIG. 3 show a dimple 7 at the repair site of 1.0 inches compared to sample specifications for allowable displacement for this representative part equaling 0.050 inches. Because the calculated displacement exceeded the allowable displacement, ARPPAS indicated that the allowable parameter values had been exceeded by posting a STOP sign.

At this stage of Example 1, the product of analysis by ARPPAS for this representative part indicates a preference for a different repair material such as a graphite textile that is stiffer than the original panel glass composite. ARPPAS is used to conduct further analysis, calculating and depicting the displacements predicted after completing the repair process, using the same steps as above, except as detailed below, where the material properties of the stiffer graphite are substituted for the original composite glass:

Step 6′: ARPPAS queries an electronic database for the composite materials approved for repair of this part, for example 5 ply Graphite, an alternative repair material.

Step 7′: The approved options are loaded into the GUI. Once the approved options are loaded into the GUI, the popup window with the approved available material options turns a characteristic color (for example yellow) alerting the user to the requirement for their selection. The user then selects exactly one of the options. (Note that here and in all other instances, the GUI is only a convenient means to enter the needed data. Other formats, such as data or text files, would alternatively produce acceptable functionality. User of a GUI is not intrinsic to ARPPAS function.) Using the current practice, the user selects the new composite material, 5 ply Graphite.

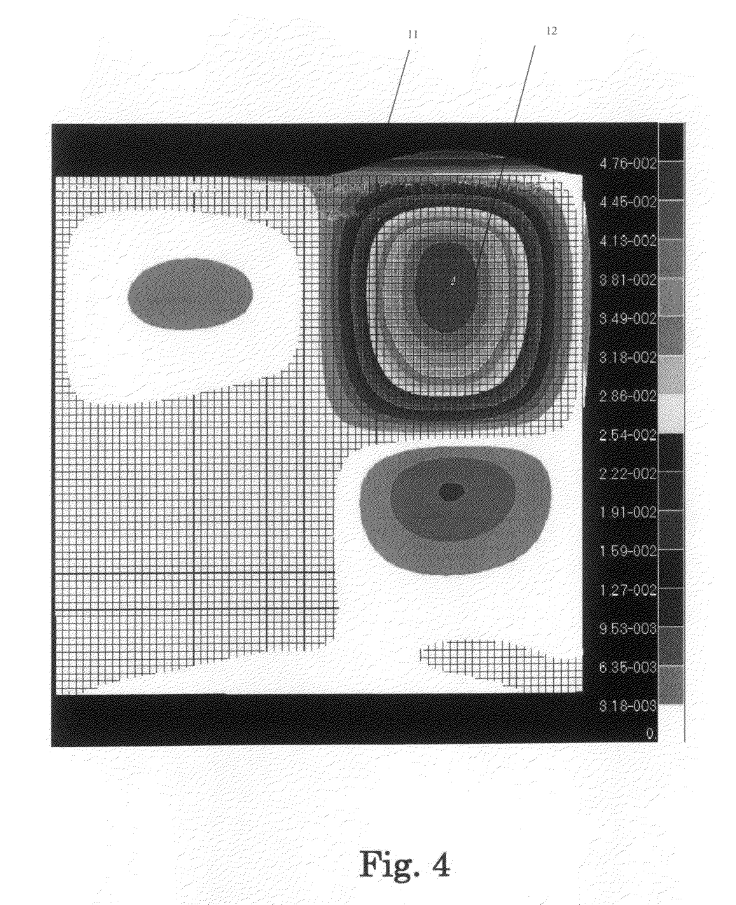

This time, the analysis shows that the maximum displacement, 0.045 inches, does not exceed the allowable displacement of 0.05 inches, so the part passes and the repair may proceed. ARPPAS shows this result graphically on a chart 11 as shown in FIG. 4. This time, the dimple 12 is within acceptable specifications. A green ‘GO’ sign is also displayed in the GUI, demonstrating that this repair would meet all applicable acceptance standards.

Thus, the product of analysis by ARPPAS shows that current practice, using a repair technique that replaces the damaged material with a patch made from the original material, would result in unacceptable displacements due to the repair-induced residual stresses and strains, displacements up to 1.0 inch deep at that center of the repair area, and causing the side panels to bulge outward about 0.25 inch near the corner. These repair-induced displacements would cause the repaired section to be unserviceable, for example, perhaps deforming the part so much that it could not be put back on the airplane, or even if somehow reattached by use of inappropriate force, it would not have an acceptable surface contour due to the repair-induced dimple. In practice, the part repaired using current practice would likely have to be scrapped, but the requirement to scrap the part would not be understood until after the substantial time and effort required for the unsuccessful repair had been expended. In the meantime, the airplane would be unavailable for service, costing substantial additional expense in financing charges and lost revenue.

### Example 2

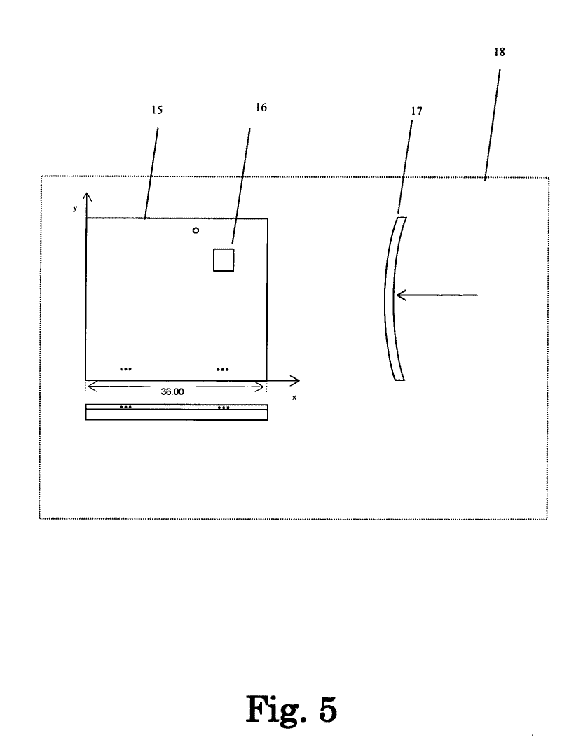

Example 2 demonstrates how ARPPAS operates to achieve an accurate repair analysis of a composite aircraft part that has had a previous repair. Consider the case of a representative aircraft part, as depicted in FIG. 5, with a curvature similar to a fuselage access door 17 having a reinforced composite panel 15 having square dimensions of 36 in. per side with a needed repair centered at (25,26) on the part whose overall dimensions are 36 in. by 36 in. The part has already had a 4 in. by 4 in. repair 16 centered at coordinates (27,27) composed of graphite composite material, the last previous repair state. The part had been previously analyzed using ARPPAS and the earlier repair had been found to be acceptable, using a process as described previously in Example 1, but with the geometric specifications that define this particular repair instance, as described above and in more detail below.

One of the functions accomplished automatically during the prior ARPPAS analysis was a database record to reflect the engineering characteristics, location, and extent of the prior repair. This example shows one such earlier repair, but there are no limits to the numbers and relative orientation of prior repair records stored in the database. Such repairs may even overlap or completely supersede earlier repairs, native structure, or both earlier repairs and native structure. When the particular part ID is selected from among the candidates listed in the GUI, the latest version of that particular part with its entire part repair history is automatically selected, since that is representative of the last known part repair state. It may be appreciated that earlier versions of the particular part with the then current repair state are also stored in the computer database, so selection of the latest version is a convenience to the user but is not a limit on the invention's scope. Earlier versions of a repaired part might alternatively be selected. A newly defined part record derived from the original design, as for a particular part that is being repaired for the first time that has not yet been entered into the database, might also be selected for analysis by entering a new part ID corresponding to that particular part and specifying the part type. The new individual instance of the part would be defined by particularizing a generic part type engineering description stored in an accessible database and associating the newly particularized part description with the newly establishes Part ID in the database record(s).

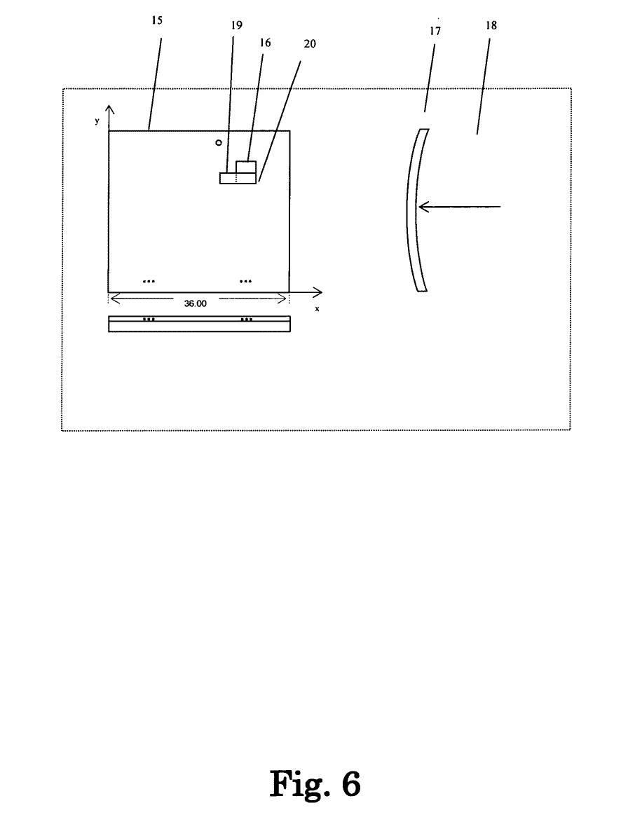

In this example, the original panel surface is specified as a fiberglass composite material, for example five layers of Cytec CE 9000/7781 prepreg fiberglass. Consequently, the projected repair state includes: (1) the original material in portions of the part not shown in the current view; (2) the 5 ply prepreg fiberglass of the native part panel shown in the selected view (FIG. 6); (3) the previous 4 in.×4 in. graphite composite repair 16; and (4) the newly defined fiberglass composite repair also shown in this view of the part 19.

As shown in FIG. 6, the newly defined additional current repair 19 is centered at (25,26), is 2 in. high and 9 in. wide. The current repair partially overlaps the previously defined prior repair area as depicted by the intersection 20.

The 3 dimensional shape of the composite patch becomes substantially fixed after the composite repair material has been processed and cured at an elevated temperature, the heat source is removed from the composite repair, and the repair area temperature subsequently drops below the composite material glass transition temperature, which for this Cytec prepreg material is about 350 degrees F. As the part continues cooling and the temperature falls below that temperature, the patch shrinks. The amount of shrinkage is substantially determined by, inter alia, 1) the cured composite material's coefficient of thermal expansion and 2) the difference between the glass transition temperature and the ambient temperature of the part. Other physical phenomena that might be included in the analysis and are within the scope of the components of ARPPAS used in this example, such as natural frequencies, resonant response, buckling margin, etc., that can also affect the post-repair shape or otherwise affect the suitability for continued service and that can potentially be compared with standards and used as acceptance criteria for the part repair, are also included within the scope of the invention. This shrinkage of the repair causes the entire part to contract in the direction of the repair, leading to unavoidable and often undesirable displacement and residual stresses and strains. ARPPAS predicts these effects very quickly during the repair planning process, well before the actual repair is begun. The elapsed time for a complete cycle of analysis using ARPPAS in its current implementation on a laptop computer, with the particular data used in Example 2, from part selection to viewing results, took 110 seconds, in contrast with the days or weeks required for comparable analysis using conventional practices.

As shown in Example 2, because ARPPAS offers the repair planner alternative selections, including a preferred repair material, such as a much stiffer graphite composite material, and a means to compare the results of the alternative material on the repair figures of merit, the repair planner has the heretofore unavailable means to perform analysis-based repair planning quickly and accurately, and base the repair plan on the comparative benefits of alternative repair strategies. For economic and operational reasons, there is tremendous pressure on maintenance crews to repair aircraft and return them to service. Analysis results delivered in less than 2 minutes, as provided by ARPPAS, enable their practical incorporation in repair planning, a capability that is not practically available using current practice because of the conflict between the long time to prepare and perform an analysis, and the contrasting very short time available to plan for, or to optimally effect repair of an aircraft and its parts.

After identifying this particular part and its need for repair and defining the repair area, analysis by ARPPAS is conducted as follows:

Step 1: The individual part ID is selected from the list of part ID's, each of which corresponds to a discrete part and its unique repair history, available from the electronic database and presented to the user via the GUI. ARPPAS by default sorts through all of the records for that particular part ID, each of which includes the engineering data corresponding to an individual instance of that particular part's repair history, stored in the database and displays the latest data to the user. Since each incremental record includes reference to data for that particular part that includes the sum of all previous repairs, the latest version of that part's reference data would have the most current record of accumulated repairs. There is no limit to the number of repair records that might be included in the database for any particular part. It may be appreciated that any prior repair state, earlier than the latest stored version, might also be selected for analysis in ARPPAS.

Step 2: The user selects the view of the selected part that shows the affected area.

Step 3: Upon user selection, ARPPAS by default posts an engineering drawing 18 of the selected view including graphical representation that includes all of the previous repair(s) 16 on the part view, and repair definition(s) that had been automatically recorded in the electronic database for that part during prior analysis(es) of the part for earlier repairs. It may be appreciated that posting the latest graphic is not intrinsic to ARPPAS operation, but is a convenience for the user. It may also be appreciated that all portions of the part and all repairs to all portions of the part may be represented in the database representation of that part, but there may only be a minority of, or even none of, the previous repairs displayed in the particular part view selected by the user.

Step 4: The newly defined current repair geometry is entered into a computer via the GUI. ARPPAS digitizes the repair geometry, and converts it into machine readable electronic data.

Step 5: The newly defined repair geometry is visually displayed on the engineering drawing posted on the GUI, providing visual feedback for the user. By default, a visually distinct construct, such as a red color, is used to distinguish the new repair definition from prior repair definitions.

Step 6: ARPPAS queries an electronic database for the composite materials approved for repair of this part 15, for example 5 ply Cytec CE 9000/7781, the original material used for manufacturing the virgin part.

Step 7: The approved composite material repair options are loaded into the GUI. Once the approved options are loaded into the GUI, the popup window with the approved available material options turns a characteristic color (for example yellow) alerting the user to the requirement for their action, for example, selection of an approved material from a pop-up menu. In that case, the user then selects one of the available composite material options. Upon user selection of any material, the background color reverts to a neutral tone, in this case white. ARPPAS disables data entry for additional items that depend on the current selection unless and until the current data entry is complete. For example, the user cannot enter an angular orientation for a composite material unless and until the user selects a material that requires an angular orientation. Similarly, the user is not allowed to select display of output data from the current repair state until the data processing that produces the output data is complete. (Note that here and in all other instances, the GUI is only a convenient means to enter the needed data. Other formats, such as data or text files, would alternatively produce acceptable functionality. Use of a GUI is not intrinsic to ARPPAS function.) Basing material selection on the current practice standards for repair of composite aircraft parts, the user selects the original composite material, 5 ply Cytec CE 9000/7781 for the new repair.

Step 8: ARPPAS then queries the appropriate database again to see if any additional information is required from the user to fully define the material use. For example, if the database record for the material indicates that it has a preferred angular orientation, then ARPPAS will reconfigure the GUI to provide a means for the user to enter the needed data, again changing color to alert the user to the need for additional data entry. The user then enters the data as required.

Step 9: ARPPAS checks to verify that all required user inputs have been specified.

Step 10: Once all user inputs are complete, ARPPAS offers the user several options related to program execution, for example, execute the analysis, update the geometry without executing the analysis, abort the analysis, exit the program, etc. The use selects exactly one of the available options.

Step 11: If the user elects to execute the analysis, the program stores the data related to the new repair in a database unique to that part, incorporating the newly defined repair material characteristics and its geometry into an updated digital representation of the current repair state, along with the remaining native material and prior repairs. The newly defined repair characteristics supersede the characteristics of the native material and any previous repairs in its application area. ARPPAS then automatically queries the database again to assemble additional data needed for the analysis, such as the material properties of the portion of the part where the newly defined repair is located, its glass transition temperature (note that ‘glass transition temperature’ refers to the chemical and physical characteristics of the cured composite material, not the composition of the constituent textiles in the composite material such as fiberglass or graphite), the same types of information for all prior repairs, the details of the textile plies and their relative orientation in the composite material for the newly defined repair and for prior repairs, the material properties and geometry of the rest of the part, additional applied loads (such as overpressure or vibration loads at certain locations on the part) and boundary conditions and constraints (such as displacement at one or more points on the part). ARPPAS then automatically assembles all needed geometry, material information, loads, and thermal information into a machine readable file (for example, a bulk data file used in finite element analysis). ARPPAS then stores the machine readable data file and processes the data in the file (for example, using MSC Nastran) to produce an analysis output data file (for example, an xdb file). ARPPAS then automatically executes another data processing program (such as MSC Patran) to extract the geometry, displacements, stresses, strains, and other engineering data related to the repair configuration from the analysis output file. The data extracted include, for example, the maximum displacement of the part due to the repair-induced and other applied loads, the maximum shear stress, the maximum shear strain, the maximum principal strain, maximum shear strain, etc, and graphical displays of these data.

Step 12: ARPPAS then again queries the database for approved values of allowable parameters for a variety of engineering data, such as stress, strain, displacement, etc, and compares the calculated data with the allowed parameters. (It may be appreciated that a wide range of engineering data are available from automated structural analysis programs such as finite element programs, and that various of these engineering analysis results may also or alternatively be compared with standards and used as acceptance criteria for the repaired part.)

Step 13: If the calculated engineering analysis output data do not conform to the approved limits for those parameters, then the existence of a nonconformance is visually displayed in the GUI by use of characteristic colors and symbols, such as red highlights and a red STOP sign similar in proportions and color to a traffic sign. If, on the other hand, all data conform to the acceptance standards, then a symbolic green GO sign is displayed in the GUI. These data are also recorded in the database for this repair.

Step 14: ARPPAS automatically loads the user-selectable graphical plots of engineering data into the GUI for display to the users. Thus the user enjoys not only unambiguous indications of compliance or non-compliance with the engineering acceptance standards for the planned repair, but also the ability to examine the details of the results in a convenient graphical format.

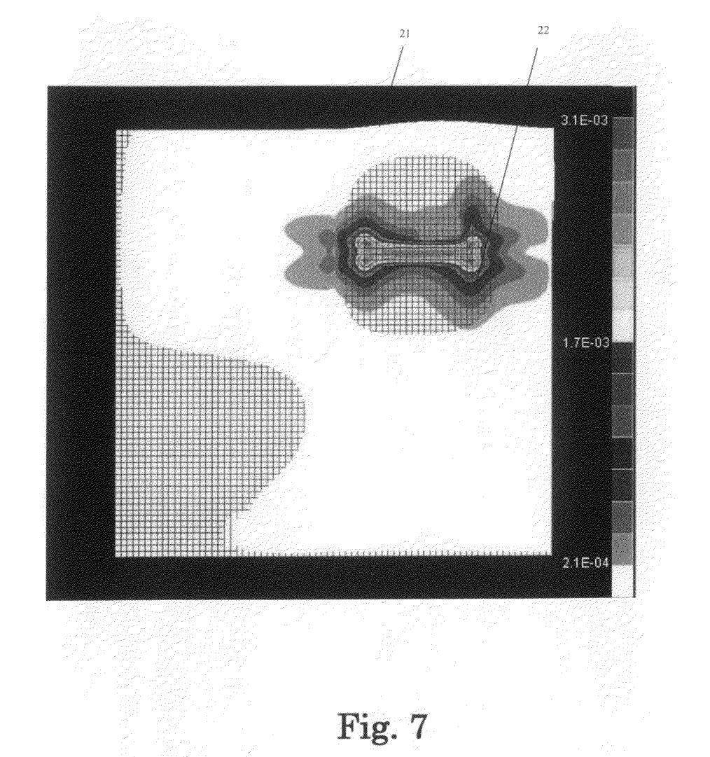

The results of ARPPAS for this example, depicted as a chart 21 in FIG. 7, show an unacceptable dimple 22 at the repair site of 0.167 inches compared to sample standards for allowable displacement for this representative part equaling 0.050 inches. Similarly, the calculated maximum shear strain of 3,170 microstrain exceeded the allowable shear strain limit of 1,000 microstrain. ARPPAS indicated that at least one of the allowable parameter values had been exceeded by posting a STOP sign. ARPPAS also indicated visually which of the acceptance criteria had been exceeded by changing the background color of their respective graphical display selection boxes to red. Consequently, the user received unambiguous indication that at least one acceptance criterion had been exceeded, rendering the part unusable, and was able to interpret the engineering analysis results accurately with no requirement that the user have specialized engineering skills or training. The user also received an unambiguous indication that a plurality of acceptance criteria had been exceeded, which particular standards had been exceeded, and also an unambiguous indication of where on the part they had been exceeded, all of which is useful information for engineering evaluation of alternative repair formulations.

Therefore, ARPPAS identifies that the prospective repair is not recommended and offers the user the option of analyzing the same repair using alternative materials. For example, the user might consider alternative use of a much stiffer graphite composite material instead of the native glass composite. The user would discover, by a process as detailed below, that use of this alternative repair material results in much smaller repair-induced displacements, only a few percent of the previous displacements, and an acceptable repair based on the objective repair acceptance criteria.

At this stage of Example 2, the product of analysis by ARPPAS for this representative part indicates a preference for a different repair material such as a graphite textile that is stiffer than the original panel glass composite. ARPPAS conducts further analysis, calculating and depicting the displacements predicted after completing the repair process, using the same steps as above, except as detailed below, where the material properties of the stiffer graphite are substituted for the original composite glass:

Step 6′: ARPPAS queries an electronic database for the composite materials approved for repair of this part 15, for example a 5 ply graphite composite material.

Step 7′: The approved composite material repair options are loaded into the GUI. Once the approved options are loaded into the GUI, the popup window with the approved available material options turns a characteristic color (for example yellow) alerting the user to the requirement for their action, for example, selection of an approved material from a pop-up menu. In that case, the user then selects an option. Upon user selection, the background color reverts to a neutral tone, in this case white. ARPPAS disables data entry for additional items that depend on the current selection unless and until the current data entry is complete. For example, the user cannot enter an angular orientation for a composite material unless and until the user selects a material that requires an angular orientation. Similarly, the user is not allowed to select display of output data from the current repair state until the data processing that produces the output data is complete. (Note that here and in all other instances, the GUI is only a convenient means to enter the needed data. Other formats, such as data or text files or manual data entry, would alternatively produce acceptable functionality. Use of a GUI is not intrinsic to ARPPAS function.) Basing material selection on the prior ARPPAS results, the user selects a 5-ply graphite for the new repair.

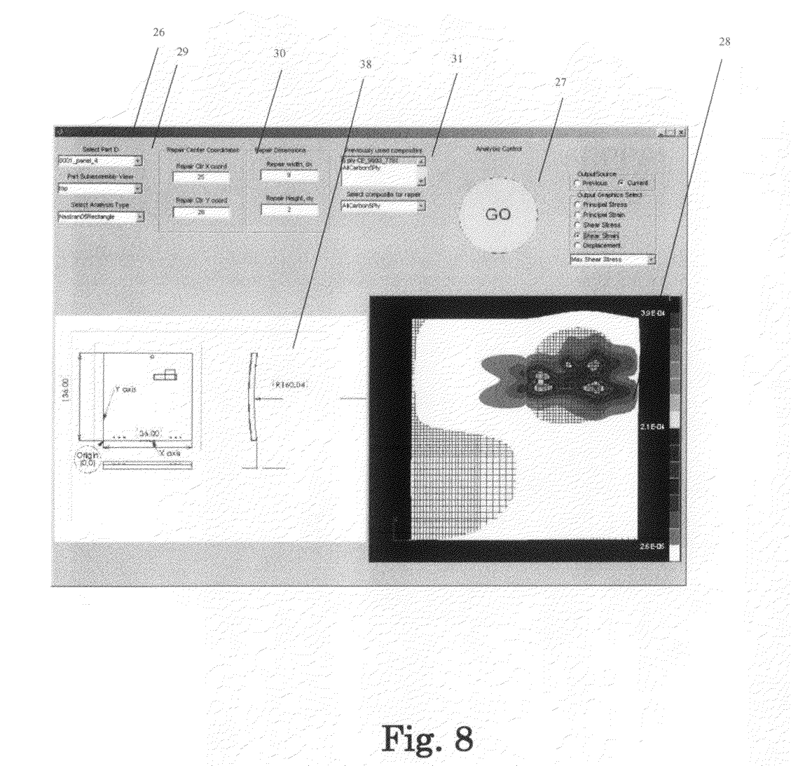

ARPPAS automatically loads the user-selectable graphical plots of engineering data into the GUI for display to the users, as shown in FIG. 8. FIG. 8 shows a screen shot 26 of the final results of ARPPAS as shown on the GUI. The screen shot 26 contains the data identifying the part 29 and the location of the repair 30 along with a menu containing the previously used composite materials and composite selected for the current repair analysis 31. The GUI further provides a detailed display 28 of calculated shear strain contours provided by ARPPAS. A circular “GO” sign 27 appears prominently, showing that the repair yields acceptable results. Thus the user enjoys not only unambiguous indications of compliance or non-compliance with the engineering standards for the planned repair, but also the ability to examine the details of the results in a convenient graphical format, as seen in chart 28.

This time, ARPPAS indicates a suitable repair resulting in a maximum shear strain of 389 microstrain, within the 1,000 microstrain acceptance limit. The repair is otherwise suitable, and part repair may proceed using the specified alternative graphite repair material with high confidence that the part will be suitable for service after repair is complete.

### Comparative Example (Conventional Repair) to Example 2

Current maintenance practice is to replace damaged composite material with substantially identical replacement material. If a repairable composite portion of an aircraft part is made of a particular kind, orientation, and thickness of fiberglass, then typical repairs would specify use of the same fiberglass composite material for repairs to that area, processing it the same as the original material. For example, five layers of new Cytec CE 9000/7781 prepreg fiberglass, each with the correct size to cover a 9 inch by 2 inch repair area as a second repair on a composite aircraft part, as described in the immediately preceding example detailed above would be cut and laid into the newly defined panel cutout area. A base and cover, such as metal plates with the intended final surface curvature, would be applied to both sides of the patch.

The temperature of the patch would then be raised by the application of external heat to cure the prepreg materials while pressure applied to both top and bottom cover would assist processing to achieve maximum practical material strength by, for example, compacting the material and squeezing excess air out of the patch material, also assuring conformance of the repair with the covers that produce the desired final shape, for a period of time of the order of an hour. (The actual cure period can change, depending on several factors, and this hypothetical example is only representative.). After curing at the prescribed elevated temperature, the part is then allowed to cool and the covers are removed. The shape of the composite patch becomes fixed when its temperature drops below the glass transition temperature, which for this material is about 350 degrees F. As the temperature falls below the glass transition temperature, the repair patch shrinks. The amount of shrinkage is determined by the cured composite material's coefficient of thermal expansion and the difference between the glass transition temperature and the ambient temperature of the part. This shrinkage causes the entire part to contract in the direction of the repair, leading to unavoidable and often undesirable displacement and residual stresses and strains.

In this example, by applying conventional repair techniques, the repair results in a dimple at the repair site of 0.167 inches compared to sample specifications for allowable displacement for this representative part equaling 0.050 inches. Because the repair-induced displacement exceeds the allowable displacement, the part repaired using conventional practice would likely have to be scrapped, but the need to scrap the part would be discovered only after the repair. It can be appreciated that a substantial amount of resources, time, and effort are required to accomplish all of the steps involved in a conventional composite aircraft part repair, including but not limited to preparing the part to accept the repair, procuring and handling the replacement part, preparing repair covers to compact the material and achieve the desired finished shape, providing a sufficient work area, applying controlled heat and pressure, etc. By preparatory use of ARPPAS for repair planning, the user can achieve several heretofore unachievable goals. First, the user can rapidly predict whether the substantial time and effort to repair the part is likely to achieve success, thereby supporting a rapid decision to either repair the part or procure a spare part, assuring desirable minimum time to return the aircraft to service. Second, if the user determines that the part can likely be successfully repaired, the user can use the results of ARPPAS to help determine the shape of the repair fixtures, particularly the compacting covers, to assure that the finished part will assume the proper shape. This is particularly important if the composite materials available to repair the part are limited as, for example, if the part is made of special materials such as the quartz textiles often used in radomes, that must be substantially identical to the original material such that the repaired part achieves functional capabilities that preclude use of alternative composite materials. And third, if the user is limited to already manufactured tooling that cannot be readily altered, the user may use ARPPAS to determine which if any of the alternative materials available for the repair may be used with the existing tooling and still provide acceptable repairs.

Comparative Example 2 therefore shows the advantage of using the ARPPAS analysis over current practice, where using a repair technique that replaces the damaged material with a patch made from the original material results in unacceptable shear strains or finished geometry due to the repair-induced residual stresses and strains, in this example, repair process-induced forces caused strains as high as 3,170 microstrain, potentially inducing unacceptable cracks in the repaired part, and static deformation as high as 0.167 inches. Such repair-induced cracks or static deformations would cause the repaired section to be unserviceable. In practice, the part repaired using current practice would likely have to be scrapped, but the requirement to scrap the part would not be understood until after the substantial time and effort required for the unsuccessful repair had been expended. In the meantime, the airplane would be unavailable for service, costing substantial additional expense in financing charges and lost revenue, or potentially, inability to perform a needed mission.

The table below provides data of unexpectedly superior results of using ARPPAS.

### Repair Characteristics of ARPPAS Compared to Repair Characteristics for Conventional Repair.

| | Maximum | | |
|---|---|---|---|
| Repair Method: | Shear Strain: | | Assessment |
| ARPPAS-validated alternative (Ex. 2) | 389 | microstrain. | acceptable |
| Conventional practice (Comp. Ex.) | 3,170 | microstrain | unacceptable |

Analysis by ARPPAS thus has the unexpected result that specifying repairs exclusively using the materials from which a part was originally manufactured, the current practice for composite aircraft part repairs, may cause unacceptable repair characteristics, while use of an alternative material would enable a successful repair. It is not possible to reliably predict such results without a detailed engineering analysis of the part such as the analysis embedded in ARPPAS. It is not practical to manually calculate the displacements for such parts because of the need to rapidly complete the analysis before the repair process is begun, validating a successful repair strategy, contrasted with the substantial time required to perform a structural analysis of the part's repair-induced effects using traditional techniques, especially de novo model creation, or manual modification of pre-existing models for finite element analysis. Such analysis processes will return results too late to affect decisions concerning planning the repair process. While its use in repair planning is important to assure a successful repair, ARPPAS also provides corollary assurance of returning the aircraft to service as quickly as possible by supporting rapid decisions to procure new parts when needed.

### Example 3

This example illustrates ARPPAS as applied to an aircraft part having a reinforced panel design with reinforcing webs made of a different material than the panel cover, but comprising the same textile.

The textile of this example is CE_{—}9000_{—}7781, representative of certain aircraft parts likely to be analyzed by ARPPAS.

The panel is 36 inches by 36 inches and has 2 inch webs and an inch of curvature along proximal and distal sides.

This design is similar to what might be presented in the analysis of an access door. The boundary conditions represent a hinge along one edge. The panel is otherwise unconstrained in this example. These constraints are sufficient to calculate the response to residual tensile strains imposed by the composite repair curing process.

Additional boundary conditions and loads may be easily added to the formulation. These loads may be user selectable or prescribed by an engineer or other authority. For example, additional boundary conditions might include restraining free edges to zero displacement, representative of remounting the part onto its original location on the airplane. Additional loads might include, for example, an applied overpressure to represent the effects of aerodynamic loads and/or fuselage pressurization on the structure. In either case, the calculated structural response would include the effects of the repair-induced stresses and strains, the additional imposed boundary conditions, and the superimposed loads, applied in any combination.

Data entry and analysis are accomplished using a computer system with capabilities including electronic data processing, data input and output, graphical data display, and mass data storage. The computer system also has a capability for data entry, optionally comprising a metrology input device or a manual data input means such as a keyboard or keypad. In this example, the data input and analysis are conducted using a laptop PC hardware and Matlab, Microsoft Access, MSC Patran, and MSC Nastran software. ARPPAS provides a series of dialog boxes including for this example a ‘Select Part ID’ box; a ‘Part Subassembly View’ box, a ‘Select Composite for Repair’ box, an ‘Analysis Control’ box, an ‘Execute Analysis’ box, an ‘Output Graphics Select’ box, and an ‘Assemble Additional Engineering Data’ box.

Data entry begins with an initial data input box appearing on the computer screen. Each dialog and data input box is enabled when appropriate. For example, upon starting, the ‘Select Part ID’ box is populated with a list of part ID's corresponding to individual parts for which repair data is available as described in further detail.

The Part ID choices denote individual parts, each with their unique repair history, all of them belonging to the design class ‘0001-panel’. Their individual part ID's are shown by the trailing digit, _{—}1, _{—}2, etc. Any numbering scheme can be used, but it is important to note that each part is distinct, corresponding to its unique Part ID. The distinct part characteristics and repair history are stored in a database table dedicated to that particular part. There is no limit to the number of parts that may be included in this program, and there is no assumption that individual parts, even when repaired, are equivalent to newly manufactured parts. In the present example, the individual part is identified as: 0001_panel_{—}1.

Once a selection is made in the ‘Select Part ID’ box 36, the next step is to automatically populate the ‘Part Subassembly View’ box with available views. In this case, the selected part has only a single view stored in the database. More complex part representations in which distinct repairable subassemblies are provided with distinct views of various part aspects so the mechanic (or other user) can specify views corresponding to the location of repairs needed at the level where they will occur. Consequently, selecting the ‘view’ is actually a way for the user to activate automatically executed complex database queries that isolate portions of the structure for repair definition. For example, if a part is damaged, the damage may involve both the aerodynamic surface cover and the underlying webs. Each web would be shown as a distinct view, and the panel would be shown as a separate view, so that each can be reviewed and repairs specified. Each component repair would then be analyzed in the context of the whole part.

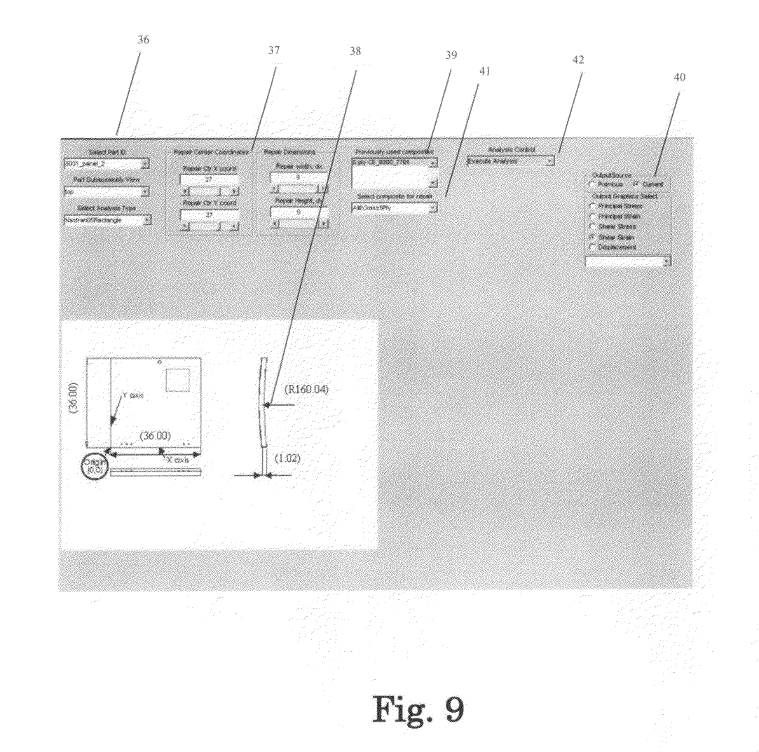

Selecting a view triggers a series of data processing events including: posting the appropriate engineering drawing 38 as shown in FIG. 9, populating the boxes specifying the repair location 37, populating the dialog box with the previously used repair materials for that part and view 39, and also populating the dialog box that allows selection of materials from an engineering-approved list 41.

Once the extent of the repair area is defined, the repair area is included in an updated engineering drawing posted on the GUI in place of the prior engineering drawing 38. The updated engineering drawing is interactively updated when the engineering inputs for the repair location are updated, either by manual entry or by use of included slider bars to nudge the dimensions.

Manual entry of data locating the repair center and repair dimensions may be required. The ARPPAS program automatically digitizes the information once the geometry is specified. In this example, input data are digitized as follows.

The coordinates of the repair centroid are transformed into the coordinate system of the selected part view's coordinate system; the repair extent limits are transformed into the coordinate system of the selected part view's coordinate system; the limits of the repair extent are mapped onto the part view's geometric model; and the portion of the engineering analysis model within the user-defined repair limits is identified and the defining characteristics of that repair within the repair limits, such as node and element identifications, are stored in computer memory for assignment of characteristics needed for the repair analysis.

The internal operations of ARPPAS do not require the use of the GUI and manual data entry, and will work perfectly well with automated data provided by automated metrology devices. Manual entry of the data into the GUI is achieved in this example by typing data into the appropriate dialog box or by subsequently activating the slider bars. Use of the slider bars modifies the data entered, a convenience for the user. Data entry for the repair area centroid is limited by the software to the range of the repairable area. Data entry defining the extent of the repair area are arbitrarily limited to no more than 25% of the extent of the repair area. The repairable area limits are stored in the database along with the drawing location where they can be easily modified by appropriate authorities, if needed, and the data input limits updated as each drawing is introduced into the program-accessible memory and database references.

When all geometric data have been entered, the dialog box with approved materials for that part and the selected view only are allowed to populate the ‘Select Composite for Repair’ dialog box 41 with approved materials. The dialog box showing materials used in past repairs provides a suitable list of reference information where and when appropriate. The user picks exactly one of the approved composite materials for the repair. Engineering management or other executive authority alone has permission to populate the material definition database table that, in this example, governs the available choices. A user such as a mechanic, untrained in engineering analysis, would typically not have permission to access or modify the composite material definitions. These composite material choices are shown as part of the overall GUI and in detail here. Each of the composite material choices is made up of specific combinations of textile plies and orientations for each ply. These are contained in the database and are used in the automatic background formulation of the engineering analysis model, but are only accessible to engineering supervisors or other authorities with specific permissions, and are typically unavailable to users such as mechanics. Those with appropriate access permission can formulate additional composite materials without limit. The acceptable materials shown to the user are based on engineering criteria stored in the database that are compared with the data entered by the user via automatic queries based on those data. In the present example, possible materials consistent with the requirement that the numbers of plies match the numbers of plies (5) in the original material, which thereby become potential selections available to the user, would include any composite material selected from the group consisting of 5PlyCE_{—}9000_{—}7781, AllSGlass5Ply, AllEGlass5Ply, CarbonGlass5PlyMix1, and AllCarbon5Ply. Additional criteria driven by the intended part use, such as compatibility with a particular electromagnetic environment, might also be included in the composite material selection criteria.

For this example, the repair material 5PlyCE_{—}9000_{—}7781 was selected. This happens to be the native material from which this surface of the aircraft part in this example was originally made. Once the user selects the repair material, the ‘Analysis Control’ dialog box 42 is populated if the composite material is isotropic, meaning that the material structural characteristics are constant in all angular orientations.

If the selected composite material is anisotropic, meaning that the material structural characteristics are different in different angular orientations, then a new dialog box automatically appears on the GUI and the user is required to enter the angular orientation between the composite material and the drawing axes. This assures entry of all information required to evaluate the structure, and also assures that superfluous information is not inadvertently included. The composite definition includes both textile information and the relative angular orientation of the plies. When combined with the required base angle orientation, complete composite repair definition, ply by ply, is achieved. For this example, the material has isotropic in-plane properties, so there is no preferred orientation for any of the plies.

One of the most important and complicated steps is ‘Execute Analysis’. When ‘Execute Analysis’ is selected from the available options presented to the user in the ‘Analysis Control’ popup box at 42, the program automatically assembles the needed structural, geometric, and process data (such as composite glass transition temperature and reference temperature) from a series of database tables, writes the data file (such as a bulk data file for typical finite element analysis) needed to support the specific CAE solver selected for the analysis, and analyzes the structural characteristics of the repair configuration. Data inputs for this example are summarized as follows:
Repair centroid x coordinate=27 inches
Repair centroid y coordinate=27 inches
Repair width=9 inches
Repair height=9 inches
Analysis type=Nastran05Rect
Number of plies specified for this specific repair in this particular region=5
Thickness per ply=0.009 inch
Glass transition temperature=300 degrees F.
Room temperature=70 degrees F.
Textile Elastic Modulus=3.36×10̂6 psi
Textile Poisson ratio=0.3
Coefficient of thermal expansion=2.0×10̂−5 per degree F.
Maximum allowed shear stress=4,000 psi
Maximum allowed principal stress=5,000 psi
Maximum allowed shear strain=1,000 microstrain
Maximum allowed principal strain=1,000 microstrain
Maximum allowed net displacement=0.05 inch
Imposed boundary condition displacement at origin=0.0 inches in any direction
Imposed boundary condition displacement at (36,0)=0.0 inches in any direction
The digitized geometry of the part including Cartesian coordinates and unique identifier, specified at each of 6,326 discrete points
The structural properties, such as composite material, the textile ply composition for that composite material, the glass transition temperature, and the room temperature, and unique identifier for each of 5,616 unique structural elements bounded by unique sets of discrete points.

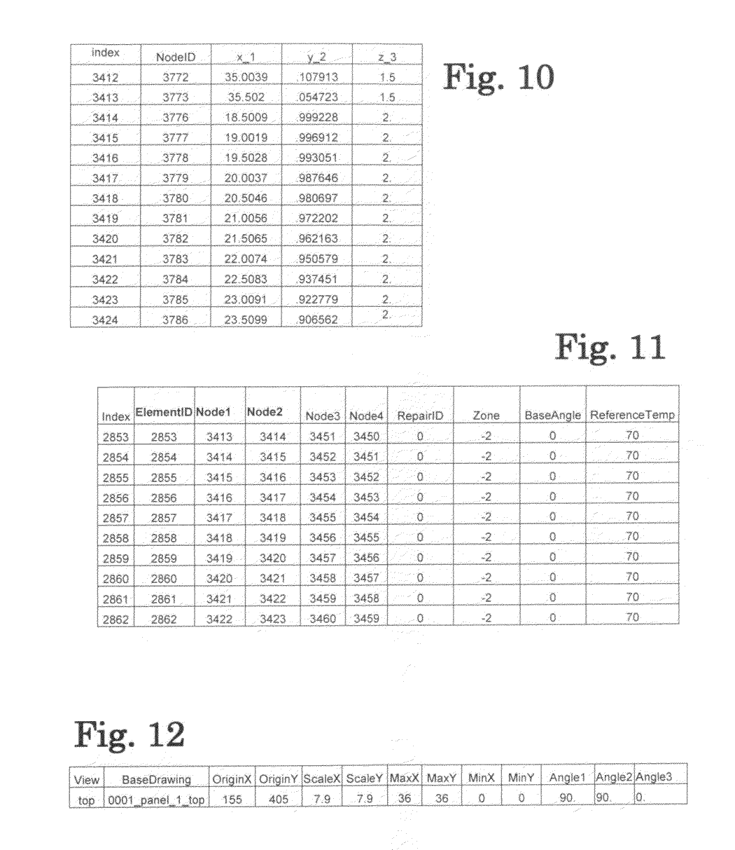

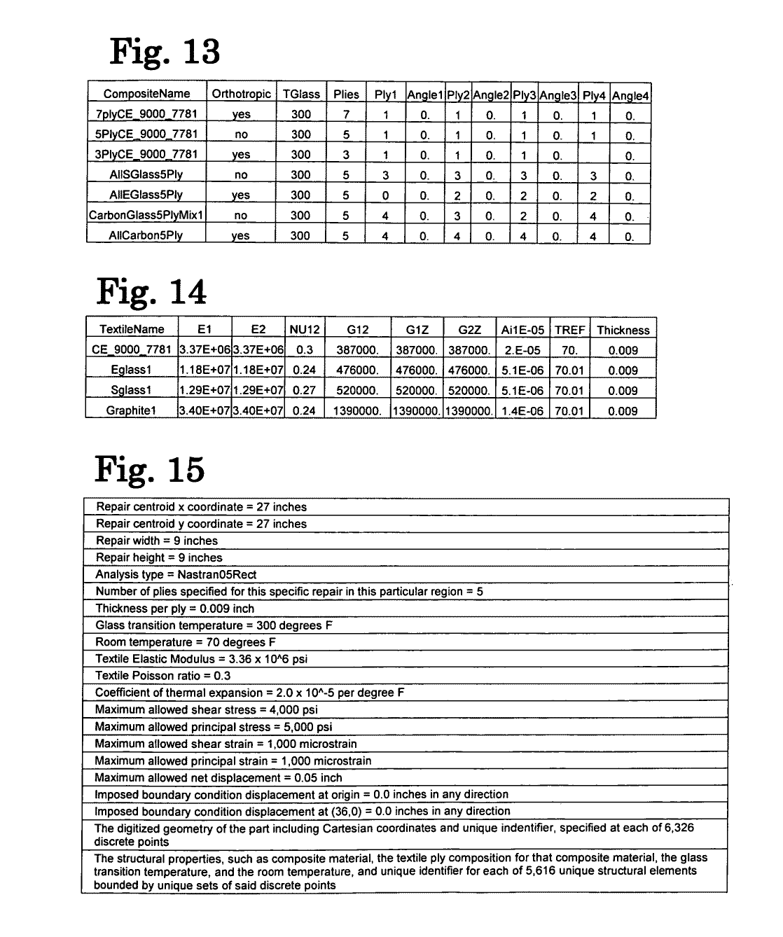

As noted, the part ID, the desired solver selection, and the geometric definition of the repair application area are specified by the user. The rest of the data needed to perform the analysis are stored in relational databases. (Note that there is no requirement to use a ‘relational database’ to store the data. Any other searchable electronic database format, such as spreadsheets or ASCII files, would also suffice. The use of relational databases in this example is a convenience.) There are two separate relational databases used to store geometrical and engineering data. The use of two separate relational databases is only a convenience and is not essential to ARPPAS. A single database or a multiplicity of databases could be used equally effectively, and would not substantially affect ARPPAS operation. One of the databases holds archival data that does not change between repair instances. This first relational database includes tables for:
Node geometric definition for each part type and view of that part. This assures that registration of the user repair geometry onto the elements will not overlap onto other portions of the part. A table used by this example appears (in part) below in the table shown in FIG. 10;
Element definition by constituent nodes for each part type and view of that part (reference information only). A table used by this example appears (in part) below in the table shown in FIG. 11; and
Data related to each view, such as the name of the view, the geometric limits for the repair area in the drawing graphic, the scale between the drawing view shown in the GUI and the actual geometry. A table used by this example appears below in the table shown in FIG. 12.
A list of engineering defined composite materials (up to 15 layers) defined by individual textile ply characteristics and their layup angle relative to the base. Combined with the user-defined base angle, this completely defines the composite material used in the analysis based on the underlying textile ply data. This is both a sophisticated and manageable approach that supports the sophisticated composite elements, defining composites layer by layer, available in many solvers. (Composite materials may be updated based on their availability to the repair community by updating this table and the accompanying textile table. This would then make the new materials available to the whole community with no additional work.) A table showing this feature for this example is set forth in the table in FIG. 13; and
A list of textile ply material engineering data used in defining the composite materials. The formulation supports orthotropic materials as well as symmetric materials. This provides complete generality in the composite definition and automated engineering analysis. (Note that this table does not change between repair instances and may be moved to the reference database.) A table showing this feature for this example is set forth in the table in FIG. 14.

The second relational database is dedicated to the incremental records queried and generated by the repair process and repair instance record keeping and includes those tables that are updated with information for individual parts and repairs. This database includes:
A master repair record holding part ID's for each part eligible for repair analysis, indices, graphic ID's, location and size of each repair, pointers to data locations, pointers to previous records, etc.; and
An element record for each part, and view that includes the element name for each eligible solver, the element nodal definition, a record of the current repair zone corresponding to its continued use of virgin material or the material used to repair that particular element (This architecture provides robustness and versatility to accommodate multiple solvers and an arbitrarily large numbers of repairs off of a common database.);

In the flow chart shown in FIG. 1 describing ARPPAS operation, there is a box 104 labeled ‘Assemble Additional Engineering Data’. There is actually quite a lot that goes on here. Summarizing that activity, the computer transforms the x and y repair coordinates provided by the user into the reference frame of the digitized part structural model coordinate system. The structural data recalled from the relational database table uniquely associate finite element nodes with particular part geometry. (This is the same process used for similar engineering analyses, and supports multiple solvers and applications.) The nodes are sorted to determine which are included within the defined and digitized repair area. A list of the included nodes is then used to sort for the elements defined by those nodes. (Again, a widely accepted practice, not tied to any particular product.) The element identification numbers for structural elements that are included within the repair area are then reported back to the main program. Material properties such as composite material definition per user input and glass transition temperature are then associated with the region specified by the included structural elements defined for the repair.

The program then automatically switches to a CAE solver-specific subroutine determined by user solver selection in the GUI. Once the subroutine is selected the process information and engineering references specific to this particular repair instance are recorded in the master Repair Record database table. Once recorded for safekeeping (in the distributed computing environment, conventionally on a server dedicated to that function but also may be provided on the laptop computer used for this example) all engineering information for the entire part needed for the analysis as described above is passed to the designated subroutine, including element identification numbers, material specification(s), thermal characteristics, etc. In this specific example this information includes the list of engineering data described above and set forth in the table in FIG. 15. The subroutine generates a bdf (bulk data file) for the entire part by querying relational databases for needed geometry and defining properties based on the user inputs and previous inputs. The bdf is specifically formatted for the solver to be used and includes the unique characteristics of the part, repair, and load characteristics. Note that the file is built fresh each time based on the reference information. This may be important to assure that the reference data remains fresh throughout the part lifetime. The bdf generated for each repair instance is stored, providing resources for additional analysis and an engineering audit trail if one should ever be required.

Once the bdf has been built it is submitted to the solver for analysis. In the present example, the bdf is a formatted ASCII text file that includes the mathematical definition of geometry, loads, materials, and boundary conditions needed to perform a finite element analysis of the part structure with the newly defined repair. The output of the analysis by MSC Nastran is a binary file called an xdb file. Other solvers may have output formatted in other formats, but will use a similar process, as one of skill in the art will readily appreciate.

Following analysis, the data is postprocessed to retrieve needed engineering data. In this example postprocessing occurs as follows:
MSC Patran is automatically opened via a programmed command generated by ARPPAS specifically for this repair instance.
The coded instructions are then interpreted by the third party postprocessing software MSC Patran. These coded instructions include the location of the xdb file which must be interpreted by MSC Patran, instructions for processing the data contained within the xdb file, and instructions for storing the output data files and graphics so that ARPPAS can perform additional data processing after the postprocessing is complete. The instructions also include generation and storage of another database in binary form that is formatted specifically for use with the postprocessing tool used by ARPPAS for this repair instance, so that users may later manipulate the same model as used in the analysis using those commercial software products, in this case MSC Patran, to produce results potentially beyond the scope of the automatically undertaken analysis within ARPPAS.
MSC Patran then executes the instructions included in the commands, producing the desired engineering data and graphical outputs, and storing the results in a specified location within a specified computer's mass memory.

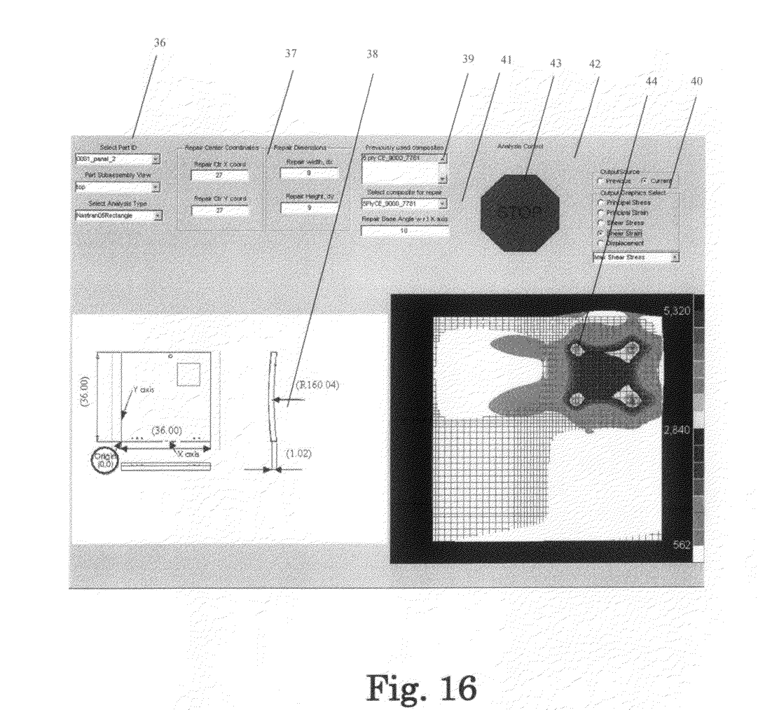

Postprocessing is now complete, and MSC Patran is closed per automated instructions. Once postprocessing is completed, ARPPAS performs several important functions as follows:
ARPPAS reads the output data files for selected engineering parameters such as stress, strain, deformation, etc., produced during postprocessing and compares the results with the previously loaded allowed values for those engineering parameters. If any of the allowed values are exceeded, ARPPAS posts a visually distinctive indicator on the user interface such as a red ‘STOP’ sign similar to the familiar traffic sign 43 as shown in FIG. 16.
When all output data have been compared to standard parameter values and no nonconformances are detected, ARPPAS posts a green ‘GO’ sign in the GUI as shown at 27 in FIG. 8.
ARPPAS loads the location of the output graphical files into the user interface so that the user can select and display the data as desired, also shown in FIG. 16 with an example display of the maximum shear strain distribution 44.
ARPPAS thus provides an automatic system for summary analysis of the suitability of this particular repair material for this particular part at this particular location on the part in accordance with predetermined engineering parameter standards for that part.

The analysis yields the following results for the entire part as a consequence of the calculated residual strains and stress due to the composite part:
Maximum shear strain of 5,320 microstrain,
Maximum principal strain of 4,230 microstrain,
Maximum shear stress of 4,860 psi,
Maximum principal stress of 6,310 psi, and
Maximum displacement of 1.00 inch.

The graphics area 44 at the lower right of the GUI is used to post the user-selectable output graphics. When postprocessing is complete, ARPPAS loads the location of graphical output files into the GUI for user selection and display of graphical output. There is no limit to the number and types of data that may be displayed in this area except for the limits imposed by the CAE program used, in this example MSC Nastran. These programs tend to provide extensive capabilities. This example shows maximum shear strain, maximum principal strain, maximum shear stress, maximum principal stress, and displacement due to the residual strain caused by the composite repair(s). Upon successful analysis execution, the ‘Output Graphics Select’ dialog box 40 is populated with the available results.

After analysis execution, when the user selects any one of the output graphics display options, the analysis output is displayed in the GUI. For this example, the maximum shear strain was selected, as shown in detail in FIG. 16 in box 40.

As shown in FIG. 16, the analysis results superimposed on a geometric representation of the part 44 and the engineering drawing 38 are shown side by side, so the user can immediately identify areas of concern on the part drawing and on the actual part. Additional detail is available to the user by clicking on the graphical display, leading to a separate graphics object that can be printed, filed, e-mailed, and otherwise analyzed. These result details show the analysis title identifying the result as the maximum shear strain, a gradient map that may be depicted in color showing the strain contours, and a (customarily) color-coded scale at right with the numerical values corresponding to the colors. It may be appreciated that a full range of additional data may also be extracted from the analysis, including strain, stress, and displacement at any point, natural frequencies, strength margins, buckling loads and margins, etc., and that those analyses are dependent on the particular part design and its repair history—relying neither on nominal data for a newly manufactured part, nor the assumption that the repaired part will have the same strength, performance, geometry, and structural characteristics as a newly manufactured part even if repaired according to existing instructions that cause repairs to duplicate as nearly as possible the original part composition. The chemistry and engineering characteristics of high strength composite part repairs preclude safe use of gross assumptions in evaluating their post-repair suitability for continued use.

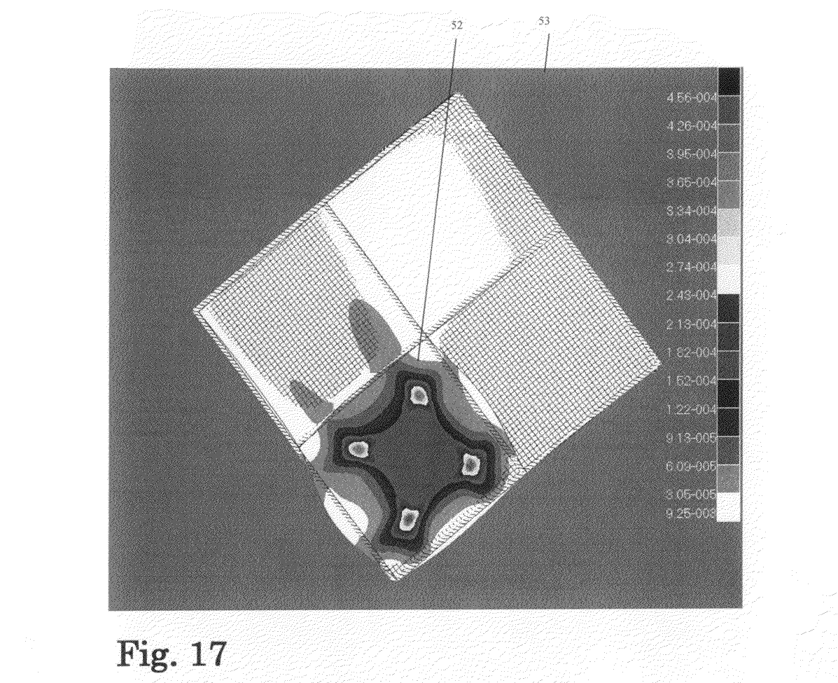

As discussed above, a specialized binary database uniquely formatted for the CAE product is used in postprocessing for this particular repair and the configuration is stored in an archive along with the bulk data file and the output results. Storing such intermediate files that are external to ARPPAS allows audits and additional detailed analysis, if required, to proceed very rapidly and accurately outside of the ARPPAS environment, starting with the exact same data used for the automatic analysis. For this example, the post processor MSC Patran operated on the xdb file to produce the output graphics and additional numeric data. While operating on the xdb file, Patran produces a Patran-specific database that includes the geometry, material characteristics, and Patran specific data. This Patran database is stored and may be used for additional analysis, should that be required. For example, an additional aspect of the output results may be desired, requiring additional analysis. One such additional aspect, showing the maximum strain distribution from below the panel (recall that the previous results were a top view only) is shown in the screenshot 53 of FIG. 17, generated using the ARPPAS-generated Patran database, showing, for example, the propagation of the shear strain 52 into the reinforcing webs that were not altered during the part repair(s), illustrating the manner in which parts that are repaired in such as way as to replicate as nearly as possible the original part composition nevertheless result in a repaired part with substantially modified properties. The expert user using Nastran, Patran, and the Patran database, with full confidence that the data matches the as-repaired part and previous analyses, might also now perform other additional analyses, such as eigenvalue analysis or thermal analysis, using the same Patran database. Other CAE programs will have similar capabilities, results, and outputs.

### Example 4

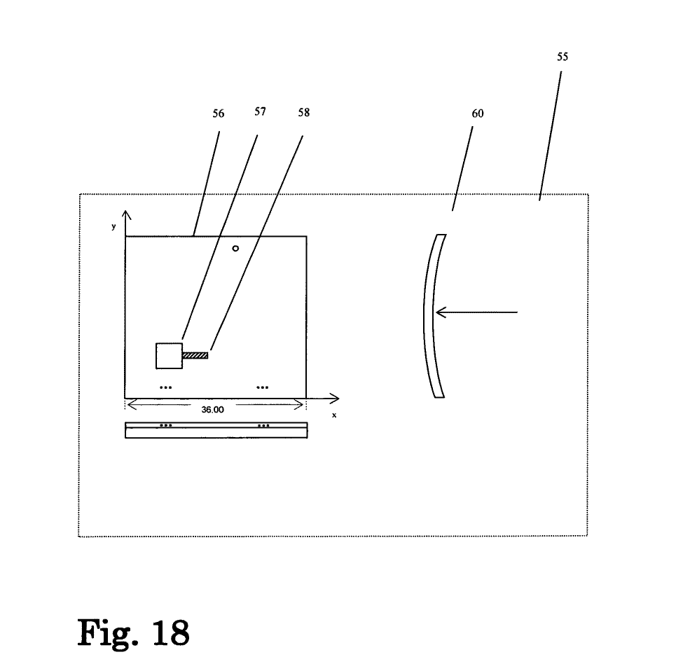

As a further example of how the capability of the present invention may be used, ARPPAS provides a way to calculate the diminished strength of damaged parts, and provides objective engineering analysis data that may be used to evaluate the serviceability of flight vehicles that include such damaged parts, based on their diminished but still potentially significant residual strength of such damaged parts. In this example, a first repair is defined, as shown in FIG. 18, with the GUI displaying an engineering drawing 55 showing the composite part 56 the repair area (prior repair) 57 centered at (9,9), with dimensions of 9 in.×9 in., composed of 5 ply graphite composite material. ARPPAS analysis shows that all loads and deformations were within allowable limits following this repair instance. This first repair causes forces within the structure due to the residual strains induced by the repair process. It may be appreciated that the excitations used to analytically evaluate the residual strength of a damaged part may also be defined as externally applied forces or constraints, and may be included as part of an automated system in which the applied loads or boundary conditions (such as force, acceleration, imposed displacement, thermal conditions, etc.) used to evaluate the residual strength of the damaged part are determined by an external computer program or manual source from which ARPPAS reads the data and evaluates the structural response to those externally defined loads or constraints. The output of ARPPAS may then be provided to the user or provided to that external program for additional data processing.

In this example, an additional structural zone (damage zone area) 58 was then defined that represents the absence of material from a specific area, representative of damage to the part in a localized area. The damage zone area 58 is centered at (18,9) and is 9 in. wide by 2 in. high. It may appreciated that the damage zone may be any shape, and that the rectangular representation shown here is a convenience.

The structural characteristics of the damage zone were analyzed using ARPPAS as follows in an elapsed time of 110 seconds as set forth below:

Step 1: The individual part ID is selected from the list of parts available from the electronic database. ARPPAS sorts through all of the repair instances of that particular part stored in the database and displays the latest version to the user, since the latest version would likely have the most current record of accumulated repairs. ARPPAS by default also uses the version of engineering data associated with the latest damage (or repair) instance for its definition of the pre-damage (or repair) part state. The additional data associated with the latest modification instance is used to incrementally modify the last previous part analytic representation, creating a new updated version that includes both prior repairs and the current modification. There is no limit to the number of repairs that might be included in the database for any particular part. It may be appreciated that any prior repair state, earlier than the latest stored version, might also be selected for analysis in ARPPAS. In this particular example, as noted above, there is a single prior repair.

Step 2: The user selects the view of the selected part that shows the affected area.

Step 3: Upon user selection, ARPPAS by default posts an engineering drawing of the selected view including graphical representation that includes all of the previous repair(s) on the part, repair definition(s) that had been automatically recorded in the electronic database for that part during prior analysis(es) of the part for earlier repairs. It may be appreciated that posting the latest graphic is not intrinsic to ARPPAS operation, but is a convenience for the user.

Step 4: The newly defined damage zone geometry is entered into a computer. ARPPAS digitizes the damage zone geometry, and converts it into machine readable electronic data.

Step 5: The newly defined damage zone geometry is visually displayed on the updated engineering drawing 55 posted on the GUI, providing visual feedback for the user. A visually distinct construct, such as a red color, is used to distinguish the new definition from prior repair or damage zone definitions.

Step 6: ARPPAS queries an electronic database for the composite materials approved for repair assessment of this part, for example 5 ply Cytec CE 9000/7781, the original material, an alternative 5 ply graphite composite material, or an alternative 5PlyNull formulation. To represent the absence of material, representative of localized structural damage, the user selects ‘5PlyNull’ from the available materials for the defined area. This choice directs ARPPAS to use de minimus values for the structural material properties of the area representing the damage zone, such as a value of 1.0 psi for the elastic modulus of the mathematical formulation for the material in the damage zone, rather than a representative value of 30,000,000 psi for graphite textile ply material or 3,370,000 psi for the Cytec CE 9000/7781 textile ply material. This approach provides mathematically acceptable results and computational stability for the missing material in the damage zone.

Step 7: The composite material options, including the 5PlyNull option, are loaded into the GUI. Once the approved options are loaded into the GUI, the popup window with the approved available material options turns a characteristic color (for example yellow) alerting the user to the requirement for their action, for example, selection of an approved material from a pop-up menu. In that case, the user then selects exactly one of the options. (Note that the GUI is only a convenient means to enter the needed data. Other formats for injecting needed data into ARPPAS, such as data or text files, would alternatively produce acceptable functionality. Use of a GUI is not intrinsic to ARPPAS function.) Using an alternative material from the list of approved materials, a 5PlyNull option, representative of missing material in the damage zone is selected for the newly defined repair.

Step 8: ARPPAS then queries the database again to see if any additional information is required from the user to fully define the material use. For example, if the database record for the material indicates that it has a preferred angular orientation, then ARPPAS will reconfigure the GUI to provide a means for the user to enter the needed data, again changing color to alert the user to the need for additional data entry. The user then enters the data as required. For this example, no additional user-provided information is required, so the program does not query the user.

Step 9: ARPPAS then checks to verify that all required user inputs have been specified.

Step 10: Once all user inputs are complete, ARPPAS offers the user several options related to program execution, for example, execute the analysis, update the geometry without executing the analysis, abort the analysis, exit the program, etc.

Step 11: If the user elects to execute the analysis, as in this example, the program stores the data related to the newly defined damage zone in a database unique to that part, incorporating the newly defined null material characteristics and its geometry into an updated digital representation of the current damage zone, along with the remaining native material and prior repairs. The newly defined damage zone characteristics supersede the characteristics of the native material and any previous repairs in its application area, in this case substituting the de minimus structural modulus parameters representing the absence of material for the prior values. ARPPAS then automatically queries the database again to assemble additional data needed for the analysis, such as the composite material properties of the balance of the viewed portion of the part where the newly defined repair is located, its glass transition temperature (note that glass transition temperature refers to the chemical and physical characteristics of the cured composite material, not the composition of the constituent textiles in the composite material such as fiberglass or graphite), information for prior repairs, the details of the textile plies and their relative orientation in the composite definition(s) for prior repairs, and, the details of the null material definition for the newly defined repair zone, as well as the geometric and material properties of the rest of the part, additional applied loads (such as overpressure, accelerations, forces, displacements, or vibration loads at certain locations on the part) and boundary conditions (such as displacement or rotation at one or more points on the part). ARPPAS automatically assembles needed geometry, material information, loads, and thermal information into a machine readable file (for example, a bulk data file used in finite element analysis). ARPPAS stores the machine readable data file and processes the data in the file (for example, using MSC Nastran) to produce an analysis output data file (for example, an xdb file). ARPPAS automatically executes another data processing program (such as MSC Patran) to extract the geometry, displacements, stresses, strains, and other engineering data related to the repair configuration from the analysis output file. The data extracted include, for example, the maximum displacement of the part due to the repair-induced and other applied loads, the maximum shear stress, the maximum shear strain, the maximum principal strain, maximum principal shear, etc., and graphical displays of these data. Additional data may be produced by additional processing of the output data and files. That data may take many forms, such as supplemental information that may be incorporated in, and used to modify or extend third party computer assisted engineering analysis, (such as part-specific superelements representative of the damaged part that might be included in a third party vehicle-level finite element analysis), or in the form of simplified engineering data (such as spring constants, influence coefficients, transfer functions, etc.) that can be incorporated in other third party analyses or hand calculations of structural performance. In any case, the additional analysis uses the residual part strength calculated by ARPPAS as inputs to the additional analysis, for example, a programmed capability derived from the process described by Wilke.

Step 12: ARPPAS then again queries the database for approved values of allowable parameters for a variety of engineering data, such as stress, strain, displacement, etc, and compares the calculated data with the allowed parameters. (It may be appreciated that a wide range of engineering data are available from automated structural analysis programs such as finite element programs, and that any or all of these may be used as acceptance criteria for the repaired part.) Step 13: If the calculated data do not conform to the approved limits for those parameters, then the existence of a nonconformance is visually displayed in the GUI by use of characteristic colors and symbols, such as red highlights and a red STOP sign similar in proportions and color to a traffic sign. If, on the other hand, all data conform to the acceptance standards, then a symbolic green GO sign is displayed in the GUI. These data are also recorded in the database for this particular damage zone assessment.

ARPPAS automatically loads the user-selectable graphical plots of engineering data into the GUI for display to the users. Thus the user enjoys not only unambiguous indications of compliance or non-compliance with the engineering standards for the planned repair, but also the ability to examine the details of the results in a convenient graphical format.

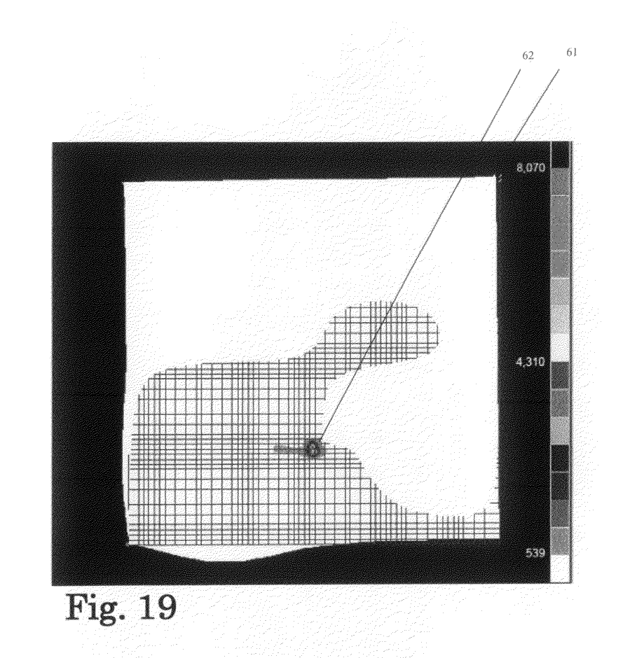

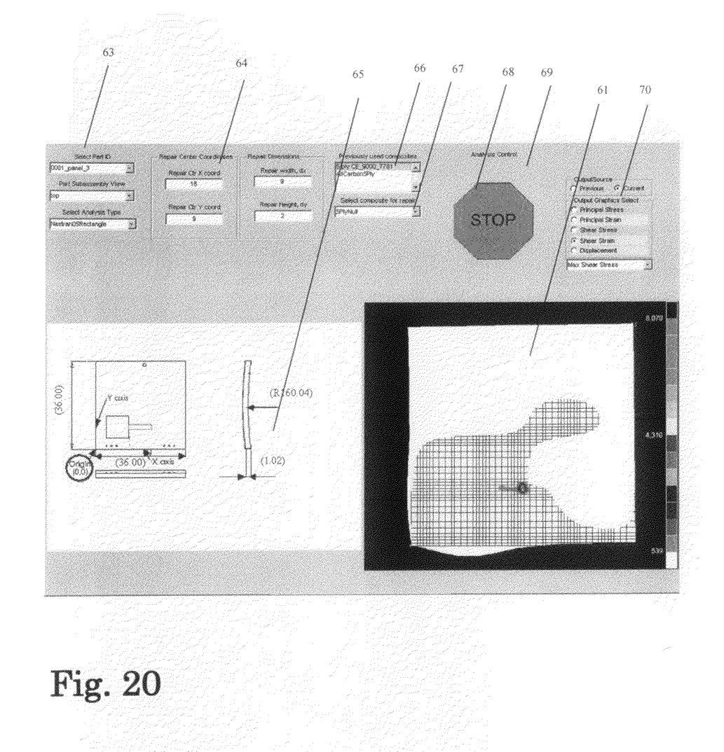

For this example, ARPPAS calculated that the material missing from a slot 9 in.×2 in. centered at (18,9), when combined with the residual strains induced by the previously acceptable repair, caused unacceptable shear strains, shear stresses, and deformations of the part. The unacceptable shear stresses and strains appear as a localized dark area in the lower right of the part. As indicated in FIG. 19, the graphical representation 61 that appears in the GUI indicates the shear strain has a localized peak value of 8,070 microstrain 62, exceeding the 1,000 microstrain limit.

ARPPAS provides comparative benefits in the automatic calculation of residual strength of damaged aircraft parts, providing the unexpected capability to rapidly analyze the structural effects of damage to the part and provide accurate assessment of its remaining residual capabilities. Analysis of such parts are not limited to those made of composite materials, but may in fact be composed of any structural material. ARPPAS has additional unique advantages for composite parts, since it includes a sophisticated composite material formulation for the composite section(s) of aircraft parts. The output of ARPPAS may be used as is to qualify the individual part for continued service, or may be combined (manually or automatically) with inputs from third party data processing capability that defines a damage zone, and also provides outputs to third party programs and data usable for hand calculations that use ARPPAS results.

This example is further described by the screenshot as shown in FIG. 19. A selection is made in the ‘Select Part ID’ box 63. Selecting a view triggers a series of data processing events including: posting the appropriate engineering drawing 55 and populating the boxes specifying the repair location 64, populating the dialog box with the previously used repair materials for that part and view 66, and also populating the dialog box that allows selection of materials from an engineering-approved list 67, in this instance, “5PlyNull.”

Once the extent of the repair area is defined, the repair area is marked and incorporated into an updated engineering drawing 65 in place of the prior engineering drawing 55. The updated engineering drawing is interactively updated when the engineering inputs for the repair location are modified by the user, either by manual entry or by use of slider bars to nudge the dimensions. “Execute Analysis” is performed from the appropriate selection from the “Analysis Control” box 69. Output is selected from the Output box 70. In this example, the shear strain has a localized peak value of 8,070 microstrain, determined to be unacceptable by comparison with preset standards, and resulting in a red Stop sign 68 displayed in the GUI.

The present invention can also be used to perform additional analyses concerning the effect of a repair on such non-structural variables such as fluid dynamics and electromagnetic wave reflectivity or directivity. Such analysis may be important to determining the viability of a repair, or assessing part performance after sustaining damage, as in Example 4.

A computational fluid dynamics analysis could be performed to examine drag or turbulence generated from a part being considered for repair. As one of skill in the art will appreciate, the appropriate computational fluid dynamics engineering analysis included within a distributed computing environment such as the Internet may be integrated as part of the present invention. Thus, important information can be gained at a forward operating location, where this information generally would not be available.

The ability to analyze the effect of a repair on electromagnetic wave reflectivity and directivity presents yet another way to integrate computational analysis into the present invention. This could be of particular use in the event of a minor damage event sustained during aerial refueling to a composite panel adjacent to a refueling receptacle. This feature would allow important analysis of the properties of a proposed repair not only in the context of structural integrity, but also for other characteristics that would determine the viability of a proposed repair or a damaged part.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for computerized integrated repair analysis of composite aircraft parts comprising:
identifying a part in need of repair analysis;
entering into a computer data describing the part;
executing an automated computer assisted engineering analysis of the individual part, wherein the computer assisted engineering analysis considers a repair process; and
determining projected properties of the individual part.

2. The method of claim 1 further comprising the step of referencing a database of parts to obtain the data describing the part.

3. The method of claim 1 further comprising the step of automatically processing user input into a bulk data file representing the part.

4. A method for computerized integrated repair analysis of composite aircraft parts comprising:
identifying a part for repair analysis;
selecting a repair area of the part;
entering into a computer data describing the part;
entering into a computer data describing the repair area of the part;
converting the data into machine-readable electronic data compatible with computer-assisted engineering analysis of the aircraft part;
selecting a repair material;
executing an automated computer-assisted engineering analysis using one or more computer programs to determine the post-repair characteristics of the part, the analysis considering:
properties of the part,
properties of the selected repair material,
characteristics of the repair processing procedures specific for the selected repair material,
effects of repair processing, and
geometries of the part and repair area; and
reporting predicted post-repair characteristics for the part.

5. The method of claim 4 further comprising the step of determining a need for repair analysis.

6. The method of claim 4 further comprising the step of referencing a database of parts to obtain the data describing the part.

7. The method of claim 6 wherein the database contains individual part histories from which data describing the part may be obtained.

8. The method of claim 6 wherein individual part history data includes data from one or more prior repairs.

9. The method of claim 4 wherein the repair material is selected from a preapproved list of repair materials.

10. The method of claim 4 further comprising the step of selecting a type of engineering analysis for determining the post-repair structural characteristics of the part.

11. The method of claim 4 further comprising the step of displaying one or more predicted post-repair characteristics for the part graphically in the form of a chart quantitatively showing the predicted post-repair characteristics of the part.

12. The method of claim 4 further comprising the steps of
displaying on a graphical user interface a graphical representation of the part identified for repair analysis;
selecting a particular display of the graphical representation of the part by entering data describing a selected display; and
displaying a particular display of the part on the graphical user interface.

13. The method of claim 4 further comprising the steps of
comparing the predicted post-repair characteristics for the part to design criteria for the part and
qualitatively reporting the results of the computerized integrated repair analysis by an indicating whether the results are acceptable.

14. The method of claim 4 wherein the engineering analysis is executed by one or more programs selected from the group consisting of finite element analysis programs.

15. The method of claim 4 wherein the engineering analysis is executed by one or more programs selected from the group consisting of NASTRAN, MSC Nastran, NE Nastran, NX Nastran, MSC Dytran, DYNA, LS Dyna, Abaqus, Algor, IDEAS, Pro/ENGINEER Mechanica, and MSC MARC.

16. The method of claim 4 further comprising the step of storing and accessing part geometric or structural engineering data from a relational database.

17. The method of claim 4 further comprising the step of storing repair analysis data in a relational database after a part has been repaired.

18. The method of claim 4 further comprising the steps of building and processing a bulk data file.

19. The method of claim 1 wherein the method is executed in a distributed computing environment.

20. An automated system for repair analysis of an aircraft part, the system comprising:
a graphical user interface;
one or more data input devices, which may include a graphical user interface which is also capable of data input;
a computer in communication with both the graphical user interface and at least one data input device;
one or more databases containing design criteria for individual aircraft parts;
one or more databases containing data describing the properties of individual composite aircraft parts, which database may be the same as the database containing design criteria;
a process for constructing a bulk data file describing a repair; and
one or more engineering analysis solvers capable of predicting post-repair properties of a part based on at least the part repair material and repair processing variables.
